(19) United States
(12) Patent Application Publication
(10) Pub. No.: US 2022/0089848 A1
(43) Pub. Date: Mar. 24, 2022

(54) Oxygen Scavenging Composition

(71) Applicant: Total Research & Technology Feluy, Seneffe (Feluy) (BE)

(72) Inventors: Daniel Libert, Court-Saint-Etienne (BE); Steven Henning, Downington, PA (US); Alain Standaert, Bruxelles (BE); Alexandre Welle, Court-St-Etienne (BE); Chantal Goreux, Seneffe (BE); Pascal Navez, Containe l'Evêque (BE)

(21) Appl. No.: 17/414,434

(22) PCT Filed: Dec. 20, 2019
(86) PCT No.: PCT/EP2019/086534

§ 371 Date: Jun. 16, 2021

(30) Foreign Application Priority Data
Dec. 20, 2018 (EP) 18214769.4

(51) Int. Cl. C08L 23/12; C08F 279/02; C08F 4/32; B65D 81/26

(52) U.S. Cl. CPC C08L 23/12; C08F 279/02; C08L 51/003; B65D 81/267; C08F 4/32

(57) ABSTRACT

The present invention relates to an oxygen-scavenging composition comprising:
at least 1.0% by weight of polybutadiene based on the total weight of the composition, wherein said polybutadiene has a number average molecular weight Mn of from 1000 to 10000 g/mol as determined by gel permeation chromatography (GPC) as described in the specification under the Determination methods; and
a polypropylene component.

The present invention also relates to the use of an oxygen-scavenging composition according to the invention for the manufacture of an article.

### FIELD OF THE INVENTION

The invention relates to an oxygen scavenging composition, processes for producing said compositions and articles comprising said compositions.

### BACKGROUND OF THE INVENTION

Today's food and drink packaging require many kinds of gas barriers for an optimal preservation. Barriers to oxygen are critical for the packaging of many solid and liquid food products (meat, fruit, and so on). The most efficient barriers to oxygen are made of a combination of a passive barrier and an active barrier, also called oxygen scavenger (OS), capable of capturing the remaining oxygen in the headspace of the container. Drawbacks of such systems include a limited efficiency when used in packaging film, a questionable compatibility with legislation, and the necessity the active species to be thermostable when incorporated in plastic packaging.

Among the most important requirements that oxygen scavenger materials have to fulfil include that they have to be harmless to the human body, not produce toxic substances or unfavorable gas or odor, be economically priced and be able to absorb a large amount of oxygen at an appropriate rate. Polyolefins, such as polypropylene generally considered safe for use in food packaging, and are economically priced; however, polyolefins are considered permeable to oxygen, and therefore cannot be used on their own as oxygen scavengers.

Current oxygen scavenging technologies still show drawbacks such as opacity of the polymer layers, sensitivity to microwaves, low efficiency, among others.

There is a need in the art to overcome the drawbacks related to the currently available oxygen scavenger compositions for food packaging. It is the object underlying the present invention to provide oxygen scavenging compositions comprising polypropylene, which provides oxygen barrier properties when used in combination with a passive barrier. It is another object of the present invention to provide oxygen scavenging compositions comprising polypropylene which are transparent, as opposed to current opaque solutions used in polyolefin packaging.

### SUMMARY OF THE INVENTION

It has now surprisingly been found that the above objective can be attained either individually or in any combination by a polymer composition as disclosed herein.

In a first aspect, the present invention provides an oxygen-scavenging composition comprising:
at least 1.0% by weight of polybutadiene based on the total weight of the composition, wherein said polybutadiene has a number average molecular weight Mn of from 1000 to 10000 g/mol as determined by gel permeation chromatography (GPC) as described in the specification under the Determination methods; and
a polypropylene component.

In a second aspect, the present invention encompasses the use of a composition according to the first aspect of the invention, for the manufacture of an article.

In a third aspect, the present invention encompasses an article comprising an oxygen scavenging composition according to the first aspect of the invention.

In a fourth aspect, the present invention encompasses a multi-layer article comprising an oxygen scavenging composition according to the first aspect of the invention.

The inventors have surprisingly found that polypropylene can be used in oxygen scavenging compositions when it is combined with polybutadiene; the resulting compositions have good oxygen capture capacity, show very little discoloration during ageing and can be readily extruded into films which have excellent gel counts. The resulting composition can have a color similar to virgin polypropylene with “no opacity effect”.

The above and other characteristics, features and advantages of the present invention will become apparent from the following detailed description.

The independent and dependent claims set out particular and preferred features of the invention. Features from the dependent claims may be combined with features of the independent or other dependent claims as appropriate.

The present invention will now be further described. In the following passages, different aspects of the invention are defined in more detail. Each aspect so defined may be combined with any other aspect or aspects unless clearly indicated to the contrary. In particular, any feature or statement indicated as being preferred or advantageous may be combined with any other features or statements indicated as being preferred or advantageous. The reference figures quoted below refer to the attached drawings.

### BRIEF DESCRIPTION OF THE FIGURES

FIGS. 1A and 1B represents photographs taken with an SEM microscope of Compositions 3 and 4 according to the invention.

FIGS. 2A and 2B represent graphs showing size distribution of the polybutadiene nodules present in Compositions 3 (FIG. 2A) and 4 (FIG. 2B) according to the invention.

FIG. 3 represents a graph showing the melt viscosity profile as a function of shear rate of compositions 3, 4, 8 and 9 according to the invention.

FIG. 4, sections A and B are photographs of moulded plaques obtained from Compositions 12, 13 and 14 according to the invention which were submitted to a discoloration test.

FIG. 5 is a photograph of the tight jar having a non-invasive oxygen sensor OxyDot placed inside the jar.

FIG. 6 represents a graph showing percentage of oxygen measured by the OxyDot sensor, plotted against the number of days the experiment took place. Measurements correspond to Composition 12 according to the invention.

FIG. 7 represents a graph showing percentage of oxygen measured by the OxyDot sensor, plotted against the number of days the experiment took place. Measurements correspond to Composition 14 according to the invention.

FIG. 8 represents a graph showing milliliters of oxygen measured by the OxyDot sensor, plotted against the number of days the experiment took place. Measurements correspond to Composition 12 according to the invention.

FIG. 9 represents a graph showing milliliters of oxygen measured by the OxyDot sensor, plotted against the number of days the experiment took place. Measurements correspond to Composition 14 according to the invention.

FIG. 10 represents a graph showing milliliters of oxygen measured by the OxyDot sensor per day, plotted against the number of days the experiment took place. Measurements correspond to Composition 12 according to the invention.

FIG. 11 represents a graph showing milliliters of oxygen measured by the OxyDot sensor per day, plotted against the number of days the experiment took place. Measurements correspond to Composition 14 according to the invention.

FIG. 12 represents a graph showing milliliters of oxygen measured by the OxyDot sensor per day, plotted against the percentage of oxygen. Measurements correspond to Composition 12 according to the invention.

FIG. 13 represents a graph showing milliliters of oxygen measured by the OxyDot sensor per day, plotted against the percentage of oxygen. Measurements correspond to Composition 14 according to the invention.

FIG. 14 represents a graph showing milliliters of oxygen measured by the OxyDot sensor per day, plotted against the percentage of oxygen. Data corresponds to Composition 12 according to the invention.

FIG. 15 represents a graph showing milliliters of oxygen measured by the OxyDot sensor per day, plotted against the percentage of oxygen. Data corresponds to Composition 14 according to the invention.

FIG. 16 represents a graph showing concentration of oxygen (%), plotted against the number of days (estimated data).

FIG. 17 represents a graph showing concentration of oxygen (%), plotted against the number of days (estimated data).

### DETAILED DESCRIPTION OF THE INVENTION

Before the present articles, processes and uses encompassed by the invention are described, it is to be understood that this invention is not limited to particular articles, processes and uses described, as such articles, processes and uses may, of course, vary. It is also to be understood that the terminology used herein is not intended to be limiting, since the scope of the present invention will be limited only by the appended claims.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. When describing the articles, processes and uses of the invention, the terms used are to be construed in accordance with the following definitions, unless the context dictates otherwise.

As used herein, the singular forms “a”, “an”, and “the” include both singular and plural referents unless the context clearly dictates otherwise. By way of example, the term “a polypropylene” means one polypropylene or more than one polypropylene.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims and statements, any of the embodiments can be used in any combination.

As used herein, the term “oxygen scavenging composition” refers to compositions which consume, deplete or reduce the amount of oxygen from a given environment.

Preferred statements (features) and embodiments of the articles, processes and uses of this invention are set herein below. Each statement and embodiment of the invention so defined may be combined with any other statement and/or embodiment, unless clearly indicated to the contrary. In particular, any feature indicated as being preferred or advantageous may be combined with any other features or statements indicated as being preferred or advantageous. Hereto, the present invention is in particular captured by any one or any combination of one or more of the below numbered aspects and embodiments, with any other statement and/or embodiment.

All quantities unless otherwise stated, are indicated with respect to the oxygen-scavenging composition.
1. An oxygen-scavenging composition comprising:
   at least 1.0% by weight of polybutadiene based on the total weight of the composition, wherein said polybutadiene has a number average molecular weight Mn of from 1000 to 10000 g/mol as determined by gel permeation chromatography (GPC) as described in the specification under the Determination methods; and
   a polypropylene component.
2. The composition according to statement 1, wherein said composition comprises at most 20.0% by weight of polybutadiene based on the total weight of the composition; preferably at most 18.0% by weight; preferably at most 16.0% by weight; preferably at most 14.0% by weight; preferably at most 12.0% by weight; preferably at most 11.0% by weight of polybutadiene based on the total weight of the composition.
3. The composition according to any one of statements 1 or 2, wherein said composition comprises from 2.0% to 20.0% by weight of polybutadiene based on the total weight of the composition; preferably from 2.0% to 18.0% by weight; preferably from 2.0% to 16.0% by weight; preferably from 2.0% to 14.0% by weight; preferably from 2.0% to 12.0% by weight; preferably from 2.0% to 11.0% by weight of polybutadiene based on the total weight of the composition.
4. The composition according to any one of statements 1 to 3, wherein the polypropylene component comprises polypropylene having a melt flow index of from 0.3 to 150.0 g/10 min as determined according to ISO 1133:1997 at 230° C. and under a load of 2.16 kg; preferably of from 0.5 to 125.0 g/10 min; preferably of from 0.7 to 100.0 g/10 min; preferably of from 0.9 to 75.0 g/10 min; preferably of from 1.0 to 50.0 g/10 min; preferably of from 1.1 to 25.0 g/10 min; preferably of from 1.3 to 20.0 g/10 min; preferably of from 1.5 to 15.0 g/10 min.
5. The composition according to any one of statements 1 to 4, wherein the polypropylene component comprises polypropylene wherein said polypropylene is selected from the group comprising a homopolymer, a random copolymer and a heterophasic copolymer and mixture thereof.
6. The composition according to any one of statements 1 to 5, wherein the polypropylene component comprises polypropylene wherein said polypropylene is a homopolymer.
7. The composition according to any one of statements 1 to 6, wherein the composition comprises from 70.0% to 99.0% by weight of polypropylene based on the total weight of the composition; preferably from 75.0% to 99.0% by weight of polypropylene based on the total weight of the composition.
8. The composition according to any one of statements 1 to 7, wherein the polypropylene component comprises polypropylene having a melt flow index of from 0.3 to 150.0 g/10 min as determined according to ISO 1133:1997 at 230° C. and under a load of 2.16 kg; preferably of from 0.5 to 125.0 g/10 min; preferably of from 0.7 to 100.0 g/10 min; preferably of from 0.9 to 75.0 g/10 min; preferably of from 1.0 to 50.0 g/10 min; preferably of from 1.1 to 25.0 g/10 min; preferably of from 1.3 to 20.0 g/10 min; preferably of from 1.5 to 15.0 g/10 min; preferably wherein said polypropylene is a homopolymer; preferably wherein the composition comprises from 70.0% to 99.0% by weight of polypropylene based on the total weight of the composition; preferably from 75.0% to 99.0% by weight of polypropylene based on the total weight of the composition.
9. The composition according to any one of statements 1 to 8, wherein the polypropylene component comprises a porous polypropylene carrier; preferably said porous polypropylene carrier has a bulk density of at most 300 kg/m³, preferably at most 250 kg/m³, preferably at most 200 kg/m³, preferably at most 150 kg/m³, for example of at least 50 kg/m³, for example of at least 70 kg/m³, for example of at least 90 kg/m³, for example the bulk density can be ranging from 80 kg/m³ to at most 250 kg/m³, for example, from 90 kg/m³ to 200 kg/m³, for example from 90 kg/m³ to 150 kg/m³, for example from 90 to 130, said bulk density being measured according to DIN EN ISO 60:1999.
10. The composition according to any one of statements 1 to 9, wherein the polypropylene component comprises from 0.5% to 20.0% by weight of porous polypropylene carrier based on the total weight of the composition; preferably from 0.6% to 18.0% by weight; preferably from 0.7% to 16.0% by weight; preferably from 0.8% to 14.0% by weight; preferably from 0.9% to 12.0% by weight of porous polypropylene carrier based on the total weight of the composition.
11. The composition according to any one of statements 1 to 10, wherein the polypropylene component comprises a porous polypropylene carrier having a melt flow index of from 0.3 to 150.0 g/10 min as determined according to ISO 1133:1997 at 230° C. and under a load of 2.16 kg; preferably of from 0.5 to 95.0 g/10 min; preferably of from 0.7 to 85.0 g/10 min; preferably of from 0.9 to 75.0 g/10 min; preferably of from 1.0 to 50.0 g/10 min; preferably of from 1.1 to 25.0 g/10 min; preferably of from 1.3 to 20.0 g/10 min; preferably of from 1.5 to 15.0 g/10 min.
12. The composition according to any one of statements 1 to 11, wherein the polybutadiene has a number average molecular weight Mn of from 1000 to 10000 g/mol as determined by gel permeation chromatography (GPC) as described in the specification under the Determination methods; preferably of from 1300 to 9800 g/mol; preferably of from 1500 to 9600 g/mol; preferably of from 2000 to 9400 g/mol; preferably of from 2500 to 9200 g/mol; preferably of from 3000 to 8000 g/mol; preferably of from 3500 to 8800 g/mol; preferably of from 3900 to 8500 g/mol.
13. The composition according to any one of statements 1 to 12, wherein the polybutadiene has a Brookfield viscosity of from 500 to 20000 cps as determined according to ISO 2555:1989 at 25° C.; preferably of from 600 to 10500 cps; preferably of from 700 to 10000 cps; preferably of from 800 to 9500 cps; preferably of from 900 to 9000 cps; preferably of from 1000 to 8500 cps.
14. The composition according to any one of statements 1 to 13, wherein the polybutadiene has a 1,2 vinyl content of at least 0.5% by weight of polybutadiene, as determined by ¹H NMR spectroscopy as described in the specification under the Determination methods; preferably of at least 1.0% by weight; preferably of at least 1.5% by weight; preferably of at least 2.0% by weight; preferably of at least 2.5% by weight; preferably of at least 3.0% by weight of polybutadiene.
15. The composition according to any one of statements 1 to 14, wherein the polybutadiene has a 1,2 vinyl content of at most 40.0% by weight, as determined by ¹H NMR spectroscopy as described in the specification under the Determination methods; preferably of at most 38.0% by weight; preferably of at most 36.0% by weight; preferably of at most 34.0% by weight; preferably of at most 32.0% by weight; preferably of at most 30.0% by weight of polybutadiene.
16. The composition according to any one of statements 1 to 15, wherein the polybutadiene has a 1,2 vinyl content of from 0.5% to 40.0% by weight as determined by ¹H NMR spectroscopy as described in the specification under the Determination methods; preferably of from 1.0% to 38.0% by weight; preferably of from 1.5% to 36.0% by weight; preferably of from 2.0% to 34.0% by weight; preferably of from 2.5% to 32.0% by weight; preferably of from 3.0% to 30.0% by weight of polybutadiene.
17. The composition according to any one of statements 1 to 16, wherein the composition comprises:
   at least 1.0% by weight of polybutadiene based on the total weight of the composition;
   wherein said polybutadiene has a number average molecular weight Mn of from 1000 to 10000 g/mol as determined by gel permeation chromatography (GPC) as described in the specification under the Determination methods; preferably at least 1.5% by weight, preferably at least 2.0% by weight; and
   a polypropylene component;
   wherein the polypropylene component comprises:
   polypropylene having a melt flow index of from 0.3 to 150.0 g/10 min as determined according to ISO 1133:1997 at 230° C. and under a load of 2.16 kg; preferably of from 0.5 to 125.0 g/10 min; preferably of from 0.7 to 100.0 g/10 min; preferably of from 0.9 to 75.0 g/10 min; preferably of from 1.0 to 50.0 g/10 min; preferably of from 1.1 to 25.0 g/10 min; preferably of from 1.3 to 20.0 g/10 min; preferably of from 1.5 to 15.0 g/10 min; preferably wherein said polypropylene is a homopolymer; and
   from 0.5% to 20.0% by weight of porous polypropylene carrier based on the total weight of the composition; preferably from 0.6% to 18.0% by weight; preferably from 0.7% to 16.0% by weight; preferably from 0.8% to 14.0% by weight; preferably from 0.9% to 12.0% by weight of porous polypropylene carrier based on the total weight of the composition.
18. The composition according to any one of statements 1 to 17, wherein the composition comprises:
   at most 20.0% by weight of polybutadiene based on the total weight of the composition;
   preferably at most 18.0% by weight; preferably at most 16.0% by weight; preferably at most 14.0% by weight; preferably at most 12.0% by weight; preferably at most 11.0% by weight of polybutadiene based on the total weight of the composition; preferably at least 1.5% by weight, preferably at least 2.0% by weight; and
      a polypropylene component;
   wherein the polypropylene component comprises:
   polypropylene having a melt flow index of from 0.3 to 150.0 g/10 min as determined according to ISO 1133:1997 at 230° C. and under a load of 2.16 kg; preferably of from 0.5 to 125.0 g/10 min; preferably of from 0.7 to 100.0 g/10 min; preferably of from 0.9 to 75.0 g/10 min; preferably of from 1.0 to 50.0 g/10 min; preferably of from 1.1 to 25.0 g/10 min; preferably of from 1.3 to 20.0 g/10 min; preferably of from 1.5 to 15.0 g/10 min; preferably wherein said polypropylene is a homopolymer; and
   from 0.5% to 20.0% by weight of porous polypropylene carrier based on the total weight of the composition; preferably from 0.6% to 18.0% by weight; preferably from 0.7% to 16.0% by weight; preferably from 0.8% to 14.0% by weight; preferably from 0.9% to 12.0% by weight of porous polypropylene carrier based on the total weight of the composition.
19. The composition according to any one of statements 1 to 18, wherein the composition comprises:
   from 1.0% to 20.0% by weight of polybutadiene based on the total weight of the composition; preferably from 1.0% to 18.0% by weight; preferably from 1.0% to 16.0% by weight; preferably from 1.0% to 14.0% by weight; preferably from 1.0% to 12.0% by weight; preferably from 1.0% to 11.0% by weight of polybutadiene based on the total weight of the composition; preferably from 2.0% to 20.0% by weight of polybutadiene based on the total weight of the composition; preferably from 2.0% to 18.0% by weight; preferably from 2.0% to 16.0% by weight; preferably from 2.0% to 14.0% by weight; preferably from 2.0% to 12.0% by weight; preferably from 2.0% to 11.0% by weight of polybutadiene based on the total weight of the composition; and
      a polypropylene component;
   wherein the polypropylene component comprises:
   polypropylene having a melt flow index of from 0.3 to 150.0 g/10 min as determined according to ISO 1133:1997 at 230° C. and under a load of 2.16 kg; preferably of from 0.5 to 125.0 g/10 min; preferably of from 0.7 to 100.0 g/10 min; preferably of from 0.9 to 75.0 g/10 min; preferably of from 1.0 to 50.0 g/10 min; preferably of from 1.1 to 25.0 g/10 min; preferably of from 1.3 to 20.0 g/10 min; preferably of from 1.5 to 15.0 g/10 min; preferably wherein said polypropylene is a homopolymer; and
   from 0.5% to 20.0% by weight of porous polypropylene carrier based on the total weight of the composition; preferably from 0.6% to 18.0% by weight; preferably from 0.7% to 16.0% by weight; preferably from 0.8% to 14.0% by weight; preferably from 0.9% to 12.0% by weight of porous polypropylene carrier based on the total weight of the composition.
20. The composition according to any one of statements 1 to 19, wherein said composition further comprises at least one transition metal catalyst.
21. The composition according to any one of statements 1 to 20, wherein said composition further comprises at least one transition metal catalyst, wherein said transition metal catalyst is a metal carboxylate.
22. The composition according to any one of statements 1 to 21, wherein said composition further comprises at least one transition metal, wherein the transition metal of said catalyst is selected from the group comprising cobalt, manganese, iron, nickel, copper, rhodium, vanadium, aluminum, chromium, zinc, ruthenium and mixtures thereof; preferably cobalt.
23. The composition according to any one of statements 1 to 22, wherein said composition further comprises at least one transition metal catalyst, wherein said transition metal catalyst is a metal carboxylate wherein the carboxylate of the at least one metal carboxylate catalyst is selected from the group comprising stearate, acetate, oleate, palmitate, caprylate, propionate, 2-ethylhexanoate, neodecanoate, octanoate, lactate, maleate, acetylacetonate, linoleate, tallate, and naphthenate.
24. The composition according to any one of statements 1 to 23, wherein said composition further comprises at least one transition metal catalyst, wherein said transition metal catalyst is a metal carboxylate selected from the group comprising cobalt stearate, cobalt oleate, cobalt 2-ethylhexanoate, and cobalt neodecanoate, ferric stearate, cerium stearate, manganese stearate, vanadium stearate and mixture thereof.
25. The composition according to any one of statements 1 to 24, wherein said composition further comprises at least one transition metal catalyst, and wherein the composition comprises from 0.005% to 0.5% by weight of at least one transition metal catalyst; preferably from 0.0075% to 0.4% by weight; preferably from 0.01% to 0.3% by weight; preferably from 0.02% to 0.2% by weight based on the total weight of the composition.
26. The composition according to any one of statements 1 to 25, wherein said composition further comprises at least one photoinitiator additive, such as for example radical photoinitiators such as the benzophenone class, or cationic type photoinitiators.
27. The composition according to any one of statements 1 to 26, wherein said composition further comprises from 100 to 10000 ppm by weight of at least one photoinitiator additive; preferably from 200 to 9000 ppm; preferably comprises from 300 to 8000 ppm; preferably from 400 to 7000 ppm; preferably from 500 to 6000 ppm of at least one photoinitiator additive, based on the total weight of the composition.
28. The composition according to any one of statements 1 to 27, wherein said composition further comprises at least one antioxidant additive; such as primary i.e. hindered phenols, secondary antioxidants i.e. trivalent phosphorous compounds, and the like.
29. The composition according to any one of statements 1 to 28, wherein said composition further comprises from 100 to 3000 ppm by weight of at least one antioxidant; preferably comprises from 120 to 2500 ppm; preferably comprises from 140 to 2000 ppm; preferably comprises from 160 to 1500 ppm; preferably comprises from 180 to 1000 ppm; preferably comprises from 200 to 1000 ppm, based on the total weight of the composition.
30. The composition according to any one of statements 1 to 29, wherein the polybutadiene is a polybutadiene homopolymer.
31. Use of a composition according to any one of statements 1 to 30, for the manufacture of an article.
32. An article comprising an oxygen scavenging composition according to any one of statements 1 to 30.
33. The article according to statement 32, wherein said article is an oxygen scavenging film.
34. A food packaging comprising an oxygen scavenging composition according to any one of statements 1 to 30.
35. A multi-layer article comprising at least one oxygen-scavenging layer comprising the composition according to any one of statements 1 to 30.
36. The multi-layer article according to statement 35 further comprising a passive polymer layer disposed on one of both sides of the oxygen-scavenging layer.
37. The multi-layer article according to statement 36, wherein the passive polymer layer comprises a polymer selected from ethylene vinyl alcohol (EVOH), polyamide, polyvinyl chloride and polymers, polyvinylidene dichloride and copolymers, polyesters such as polyethylene terephthalate (PET), polyethylene naphthenate (PEN), and their copolymers, polyacrylonitrile, polyamide aromatic (MXD6), polyethylene furanoate (PEF), and combinations thereof.
38. The multi-layer article according to any one of statements 35 to 37, wherein said article is a film.
39. A process of preparing an oxygen-scavenging composition according to any one of statements 1 to 30 comprising the steps of:
   contacting at least 1.0% by weight of polybutadiene based on the total weight of the composition, wherein said polybutadiene has a number average molecular weight Mₙ of from 1000 to 10000 g/mol as determined by gel permeation chromatography (GPC) as described in the specification under the Determination methods;
   with at least a polypropylene component.

The present invention provides an oxygen-scavenging composition comprising:
at least 1.0% by weight of polybutadiene based on the total weight of the composition, wherein said polybutadiene has a number average molecular weight Mn of from 1000 to 10000 g/mol as determined by gel permeation chromatography (GPC) as described in the specification under the Determination methods; and
a polypropylene component.

Polybutadiene

The present composition comprises at least 1.0% by weight of polybutadiene. As used herein, the terms “PBu” or “polybutadiene” are used interchangeably. Polybutadiene suitable for the present composition can be prepared according to any method known in the state of the art. Suitable polybutadiene includes polymer formed from the polymerization of 1,3-butadiene. The micro-structure of the polybutadiene can be any of the conventional types containing various amounts of 1,2-vinyl, 1,4-cis and 1,4-trans levels.

Preferably, the composition comprises at least 1.5% by weight of polybutadiene based on the total weight of the composition.

The composition according to statement 1, wherein said composition comprises at most 20.0% by weight of polybutadiene based on the total weight of the composition; preferably at most 18.0% by weight; preferably at most 16.0% by weight; preferably at most 14.0% by weight; preferably at most 12.0% by weight; preferably at most 11.0% by weight of polybutadiene based on the total weight of the composition.

In some embodiments, wherein said composition comprises from 1.0% to 20.0% by weight of polybutadiene based on the total weight of the composition; preferably from 1.0% to 18.0% by weight; preferably from 1.0% to 16.0% by weight; preferably from 1.0% to 14.0% by weight; preferably from 1.0% to 12.0% by weight; preferably from 1.0% to 11.0% by weight of polybutadiene based on the total weight of the composition.

In some embodiments, wherein said composition comprises from 2.0% to 20.0% by weight of polybutadiene based on the total weight of the composition; preferably from 2.0% to 18.0% by weight; preferably from 2.0% to 16.0% by weight; preferably from 2.0% to 14.0% by weight; preferably from 2.0% to 12.0% by weight; preferably from 2.0% to 11.0% by weight of polybutadiene based on the total weight of the composition.

In some embodiments, wherein said composition comprises from 3.0% to 20.0% by weight of polybutadiene based on the total weight of the composition; preferably from 3.0% to 18.0% by weight; preferably from 3.0% to 16.0% by weight; preferably from 3.0% to 14.0% by weight; preferably from 3.0% to 12.0% by weight; preferably from 3.0% to 11.0% by weight of polybutadiene based on the total weight of the composition.

In some embodiments the 1,2 vinyl content of the polybutadiene is of from 0.5% to 40.0% by weight; preferably of from 0.7% to 39.0% by weight; preferably of from 1.0% to 35.0% by weight; preferably of from 1.5% to 33.0% by weight; preferably of from 1.9% to 30.0% by weight; preferably of from 2.3% to 27.0% by weight of polybutadiene. The 1,2 vinyl content of the polybutadiene is determined by ¹H NMR spectroscopy, using the method described in the Example section of the application.

Advantageously the number average molecular weight Mn of the polybutadiene can range from 1000 to 10000 g/mol as determined by gel permeation chromatography (GPC) as described in the specification under the Determination methods; preferably from 1200 to 9900 g/mol; preferably of from 1400 to 9500 g/mol; preferably of from 1800 to 9300 g/mol; preferably of from 2300 to 8900 g/mol; preferably of from 2700 to 8500 g/mol; preferably of from 3000 to 8300 g/mol; preferably of from 3500 to 7000 g/mol.

In some embodiments the polybutadiene is a polybutadiene homopolymer. In some embodiments the polybutadiene is a polybutadiene grafted with olefin side chains. Polybutadiene grafted with olefin side chains may be prepared by any method known in the art. In some embodiments a functionalized polybutadiene, such as polybutadiene functionalized with maleic anhydride is contacted with a hydroxyl-terminated hydrogenated polybutadiene.

The polybutadiene can be produced by anionic, free radical, or Ziegler-Natta polymerization initiators or catalysts, as it is known in the art.

Particularly suitable polybutadiene can have a Brookfield viscosity of from 500 to 20000 cps as determined according to ISO 2555:1989 at 25° C.; preferably of from 650 to 10700 cps; preferably of from 750 to 9900 cps; preferably of from 850 to 9600 cps; preferably of from 950 to 8800 cps; preferably of from 1050 to 8400 cps.

Examples of polybutadiene suitable for use in this composition include without limitation Ricon® 131, commercially available from TOTAL Cray Valley; Lithene, commercially available from SYNTHOMER and Polyvest, commercially available from Evonik.

Polypropylene Component

The present composition comprises a polypropylene component.

In some preferred embodiments, the composition comprises from 60.0% to 99.0% by weight of polypropylene component based on the total weight of the composition; preferably from 70.0% to 99.0% by weight; preferably from 75.0% to 99.0% by weight; preferably from 80.0% to 99.0% by weight; preferably from 90.0% to 99.0% by weight of polypropylene component based on the total weight of the composition. In some preferred embodiments the polypropylene component comprises a polypropylene.

For the purposes of the present application, the term “polypropylene” is used to denote propylene homopolymer as well as propylene copolymers. The polypropylene can be atactic, isotactic or syndiotactic polypropylene. If the propylene is a copolymer, the comonomer can be any alpha-olefin i.e. any C₂ to C₁₂ alpha-alkylene, other than propylene. Preferably, if the polypropylene is a copolymer, the one or more comonomers may be selected from the group consisting of ethylene and 04-010 alpha-olefins, such as for example 1-butene, 1-pentene, 1-hexene, 1-octene, or 4-methyl-1-pentene. In an embodiment, the polypropylene is a homopolymer. In an embodiment, the polypropylene is a copolymer that can be either a random copolymer, or a heterophasic copolymer (also known as block copolymer).

In some embodiments the polypropylene component comprises polypropylene having a melt flow index of from 0.3 to 150.0 g/10 min as determined according to ISO 1133:1997 at 230° C. and under a load of 2.16 kg; preferably of from 0.6 to 130.0 g/10 min; preferably of from 0.8 to 110.0 g/10 min; preferably of from 1.0 to 100.0 g/10 min; preferably of from 1.2 to 75.0 g/10 min; preferably of from 1.4 to 50.0 g/10 min; preferably of from 1.6 to 30.0 g/10 min; preferably of from 1.8 to 20.0 g/10 min; preferably the polypropylene is a homopolymer. In some preferred embodiments, the composition comprises from 70.0% to 99.0% by weight of polypropylene based on the total weight of the composition; preferably from 75.0% to 99.0% by weight of polypropylene based on the total weight of the composition.

The polypropylene can be produced by polymerizing propylene and optionally one or more co-monomers, such as ethylene, in the presence of a catalyst system and optionally in the presence of hydrogen.

As used herein, the term “catalyst” refers to a substance that causes a change in the rate of a polymerization reaction. In the present invention, it is especially applicable to catalysts suitable for the polymerization of propylene to polypropylene.

In some embodiments, the polypropylene can be prepared using a Ziegler-Natta or metallocene catalyst system, according to any known polymerization process in the art.

In some embodiments, the catalyst can be a metallocene catalyst system. The term “metallocene catalysts” refers to compounds of Group IV transition metals of the Periodic Table such as titanium, zirconium, hafnium, etc., which have a coordinated structure with a metal compound and ligands composed of one or two groups of cyclopentadienyl, indenyl, tetrahydroindenyl, fluorenyl or their derivatives. In some embodiments, the metallocene catalyst system comprises a metallocene component, a support and an activating agent.

In some embodiments, the metallocene component is a metallocene of the following general formula: (μ-R^{a})(R^{b})(R^{c})MX₁X₂, wherein μ, R^{a}, R^{b}, R^{c}, M, X₁, X₂ have the meaning given herein. R^{a} is a bridge between R^{b} and R^{c}, i.e. R^{a} is chemically connected to R^{b} and R^{c}. In a preferred embodiment, R^{a} is selected from the group consisting of —(CR¹R²)ₚ—, —(SIR¹R²)ₚ—, —(GeR¹R²)ₚ—, —(NR¹)ₚ—, —(PR¹)ₚ—, —(N⁺R¹R²)ₚ— and —(P⁺R¹R²)ₚ—, and p is 1 or 2, and R¹ and R² are each independently selected from the group consisting of hydrogen, C₁-C₁₀alkyl, C₅-C₈cycloalkyl, C₆-C₁₅aryl, C₆₋₁₅arylC₁₋₁₀alkyl, or any two neighboring R (i.e. two neighboring R¹, two neighboring R², or R¹ with a neighboring R²) may form a cyclic saturated or non-saturated C₄-C₁₀ ring; each R¹ and R² may in turn be substituted in the same way. Preferably R^{a} is —(CR¹R²)ₚ— or —(SIR¹R²)ₚ— with R¹, R² and p as defined above. Most preferably R^{a} is —(SiR¹R²)ₚ— with R¹, R² and p as defined above. Specific examples of R^{a} include Me₂C, ethanediyl (—CH₂—CH₂—), Ph₂C and Me₂Si. M is a metal selected from Ti, Zr and Hf, preferably it is Zr. X¹ and X² are each independently selected from the group consisting of halogen, hydrogen, C₁-C₁₀alkyl, C₆-C₁₅aryl, C₆₋₁₅arylC₁₋₁₀alkyl. Preferably X¹ and X² are halogen or methyl. R^{b} and R^{c} are selected independently from one another and comprise a cyclopentadienyl ring. Preferred examples of halogen are Cl, Br, and I. Preferred examples of C₁-C₁₀alkyl are methyl, ethyl, n-propyl, iso-propyl, n-butyl, iso-butyl, and tert-butyl. Preferred examples of C₅-C₇cycloalkyl are cyclopentyl, cyclohexyl, cycloheptyl and cyclooctyl. Preferred examples of C₆-C₁₅aryl are phenyl and indenyl. Preferred examples of arylalkyl with C₁-C₁₀alkyl and C₆-C₁₅aryl are benzyl (—CH₂-Ph), and —(CH₂)₂-Ph. In some preferred embodiments, R^{b} and R^{c} are both substituted cyclopentadienyl, or are independently from one another unsubstituted or substituted indenyl or tetrahydroindenyl, or R^{b} is a substituted cyclopentadienyl and R^{c} a substituted or unsubstituted fluorenyl. More preferably, R^{b} and R^{c} may both be the same and may be selected from the group consisting of substituted cyclopentadienyl, unsubstituted indenyl, substituted indenyl, unsubstituted tetrahydroindenyl and substituted tetrahydroindenyl. By “unsubstituted” is meant that all positions on R^{b} resp. R^{c}, except for the one to which the bridge is attached, are occupied by hydrogen. By “substituted” is meant that, in addition to the position at which the bridge is attached, at least one other position on R^{b} and/or R^{c} is occupied by a substituent other than hydrogen, wherein each of the substituents may independently be selected from the group consisting of 01-C₁₀alkyl, C₅-C₇cycloalkyl, C6-C₁₅aryl, and C₆₋₁₅arylC₁₋₁₀alkyl, or any two neighboring substituents may form a cyclic saturated or non-saturated C₄-C₁₀ ring. A substituted cyclopentadienyl may for example be represented by the general formula C₅R³R⁴R⁵R⁶. A substituted indenyl may for example be represented by the general formula C₉R⁷R⁸R⁹R¹⁰R¹¹R¹²R¹³R¹⁴. A substituted tetrahydroindenyl may for example be represented by the general formula C₉H₄R¹⁵R¹⁶R¹⁷R¹⁸. A substituted fluorenyl may for example be represented by the general formula C₁₃R¹⁹R²⁰R²¹R²²R²³R²⁴R²⁵R²⁶. Each of the substituents R³ to R²⁶ may independently be selected from the group consisting of hydrogen, C₁-C₁₀alkyl, C₅-C₇cycloalkyl, C₆-C₁₅aryl, and C₆₋₁₅ arylC₁₋₁₀alkyl, or any two neighboring R may form a cyclic saturated or non-saturated C₄-C₁₀ring; provided, however, that not all substituents simultaneously are hydrogen. Preferred metallocene components are those having C₂-symmetry or those having C₁-symmetry. Most preferred are those having C₂-symmetry. Particularly suitable metallocene components are those wherein R^{b} and R^{c} are the same and are substituted cyclopentadienyl, preferably wherein the cyclopentadienyl is substituted in the 2-position, the 3-position, or simultaneously the 2-position and the 3-position. Particularly suitable metallocene components are also those wherein R^{b} and R^{c} are the same and are selected from the group consisting of unsubstituted indenyl, unsubstituted tetrahydroindenyl, substituted indenyl and substituted tetrahydroindenyl. Particularly suitable metallocene components may also be those wherein R^{b} is a substituted cyclopentadienyl and R^{c} is a substituted or unsubstituted fluorenyl.

The metallocene catalyst may be supported according to any method known in the art. The support can be any organic or inorganic solid, particularly porous supports. Preferably, the support material is an inorganic oxide in its finely divided form. Suitable support materials include solid inorganic oxides, such as silica, alumina, magnesium oxide, titanium oxide, boron trioxide, calcium oxide, zinc oxide, barium oxide, thorium oxide, as well as mixed oxides of silica and one or more Group 2 or 13 metal oxides, such as silica-magnesia and silica-alumina mixed oxides. Silica, alumina, and mixed oxides of silica and one or more Group 2 or 13 metal oxides are preferred support materials. Preferred examples of such mixed oxides are the silica-aluminas. Most preferred is a silica compound. In a preferred embodiment, the metallocene catalyst is provided on a solid support, preferably a silica support. The silica may be in granular, agglomerated, fumed or other form.

In some embodiments, alumoxane is used as an activating agent for the metallocene catalyst. As used herein, the term “alumoxane” and “aluminoxane” are used interchangeably, and refer to a substance, which is capable of activating the metallocene catalyst. In an embodiment, alumoxanes comprise oligomeric linear and/or cyclic alkyl alumoxanes. In a further embodiment, the alumoxane has formula (I) or (II)

R^{x}—(Al(R^{x})—O)ₓ—AlR^{x}₂ (I) for oligomeric, linear alumoxanes; or

(—Al(R^{x})—O—)_{y} (II) for oligomeric, cyclic alumoxanes

wherein x is 1-40, and preferably 10-20; wherein y is 3-40, and preferably 3-20; and wherein each R^{x} is independently selected from a C₁-C₈alkyl, and preferably is methyl. In a preferred embodiment, the alumoxane is methylalumoxane (MAO).

In some embodiments, the catalyst can be a Ziegler-Natta catalyst system. The term “Ziegler-Natta catalyst” or “ZN catalyst” refers to catalysts having a general formula M¹X_{V}, wherein M¹ is a transition metal compound selected from group IV to VII from the periodic table of elements, wherein X is a halogen, and wherein v is the valence of the metal. Preferably, M¹ is a group IV, group V or group VI metal, more preferably titanium, chromium or vanadium and most preferably titanium. Preferably, X is chlorine or bromine, and most preferably, chlorine. Illustrative examples of the transition metal compounds comprise but are not limited to TiCl₃ and TiCl₄.

In some embodiments, the Ziegler-Natta catalyst system comprises a titanium compound having at least one titanium-halogen bond and an internal electron donor, both on a suitable support (for example on a magnesium halide in active form), an organoaluminum compound (such as an aluminum trialkyl), and an optional external donor (such as a silane or a diether compound).

The internal donor can be selected from the group consisting of diether compounds, succinate compounds, phthalate compounds, di-ketone compounds, enamino-imine compounds and any blend of these. A mixture of internal donors can for example comprise a succinate and a phthalate or a succinate and a diether. Diether compounds are most preferred as internal donor. Ziegler-Natta catalysts comprising a diether, a succinate, a phthalate, a di-ketone or an enamino-imine as internal donor can for example be obtained by reaction of an anhydrous magnesium halide with an alcohol, followed by titanation with a titanium halide and reaction with the respective diether, succinate, phthalate, di-ketone or enamino-imine compound as internal donor.

The polymerization may be performed in the presence of a co-catalyst. One or more aluminumalkyl represented by the formula AlR^{e}ₜ can be used as additional co-catalyst, wherein each R^{e} is the same or different and is selected from halogens or from alkoxy or alkyl groups having from 1 to 12 carbon atoms and t is from 1 to 3, as well as and linear or cyclic Al-alkyl compounds containing two or more Al atoms bonded to each other by way of O or N atoms, or SO₄ or SO₃ groups. Non-limiting examples are Tri-Ethyl Aluminum (TEAL), Tri-Iso-Butyl Aluminum (TIBAL), Tri-Methyl Aluminum (TMA), and Methyl-Methyl-Ethyl Aluminum (MMEAL). Especially suitable are trialkylaluminums, the most preferred being triethylaluminum (TEAL), and triisobutylaluminum (TIBAL).

The polymerization of propylene can for example be carried out in liquid propylene as reaction medium (bulk polymerization). It can also be carried out in diluents, such as hydrocarbon that is inert under polymerization condition (slurry polymerization). It can also be carried out in the gas phase. Those processes are well known to one skilled in the art.

In some embodiments, the polypropylene component comprises a porous polypropylene carrier. The porous polypropylene carrier is preferably completely made from polypropylene, and can be provided in the form of porous polypropylene pellets.

The porous propylene carrier can be characterized by bulk density (kg/m³) which is the weight or mass per unit volume considered only for the particle itself. As used herein, the term “bulk density” refers to the weight or mass of the material divided by the total volume they occupy, i.e., includes the internal pore volume, surface area, total pore volume, pore size distribution and percent apparent porosity. The bulk density of the porous polypropylene carrier was determined according to EN ISO 60:1999.

In some embodiments the porous polypropylene carrier has a bulk density of from 50 kg/m³ to 300 kg/m³ as determined according to EN ISO 60:1999; preferably of from 90 kg/m³ to 275 kg/m³; preferably of from 90 kg/m³ to 250 kg/m³; preferably of from 90 kg/m³ to 230 kg/m³; preferably of from 90 kg/m³ to 200 kg/m³; preferably of from 90 kg/m³ to 175 kg/m³; preferably of from 90 kg/m³ to 150 kg/m³; preferably of from 90 kg/m³ to 125 kg/m³.

A non-limiting example of a suitable porous polypropylene carrier includes: Accurel® XP100-84, commercially available from Membrana GmbH, Germany.

The porous polypropylene carrier can be a propylene homopolymer or a propylene copolymer. The porous polypropylene carrier can be atactic, isotactic or syndiotactic polypropylene. If the porous polypropylene carrier is a copolymer, the one or more comonomers may be selected from the group consisting of ethylene and C₄-C₁₀ alpha-olefins, such as for example 1-butene, 1-pentene, 1-hexene, 1-octene, or 4-methyl-1-pentene. In an embodiment, the polypropylene is a homopolymer. In an embodiment, the polypropylene is a copolymer that can be either a random copolymer, or a heterophasic copolymer (also known as block copolymer).

In some embodiments, the porous polypropylene carrier can be prepared as described above for the polypropylene using a Ziegler-Natta or metallocene catalyst system, according to any known polymerization process in the art.

In some embodiments the polypropylene component comprises from 0.5% to 20.0% by weight of porous polypropylene carrier based on the total weight of the composition; preferably from 0.55% to 19.0% by weight; preferably from 0.75% to 17.0% by weight; preferably from 0.95% to 15.0% by weight; preferably from 1.0% to 13.0% by weight of porous polypropylene carrier based on the total weight of the composition.

In some embodiments the porous polypropylene carrier has a melt flow index of from 0.3 to 100.0 g/10 min as determined according to ISO 1133:1997 at 230° C. and under a load of 2.16 kg; preferably of from 0.5 to 80.0 g/10 min; preferably of from 0.8 to 50.0 g/10 min; preferably of from 0.5 to 25.0 g/10 min; preferably of from 0.5 to 10.0 g/10 min; preferably of from 0.8 to 5.0 g/10 min; preferably of from 1.0 to 5.0 g/10 min; preferably the porous polypropylene carrier is a homopolymer.

In some embodiments the polypropylene component comprises:

a polypropylene having a melt flow index of from 0.3 to 150.0 g/10 min as determined according to ISO 1133:1997 at 230° C. and under a load of 2.16 kg; preferably of from 0.6 to 130.0 g/10 min; preferably of from 0.8 to 110.0 g/10 min; preferably of from 1.0 to 100.0 g/10 min; preferably of from 1.2 to 75.0 g/10 min; preferably of from 1.4 to 50.0 g/10 min; preferably of from 1.6 to 30.0 g/10 min; preferably of from 1.8 to 20.0 g/10 min;
from 0.5% to 20.0% by weight of porous polypropylene carrier based on the total weight of the composition; preferably from 0.55% to 19.0% by weight; preferably from 0.75% to 17.0% by weight; preferably from 0.95% to 15.0% by weight; preferably from 1.0% to 13.0% by weight of porous polypropylene carrier based on the total weight of the composition.

Other Additives

The oxygen scavenging composition of the invention comprises at least 1.0% polybutadiene as oxidizable organic polymer.

In an embodiment, a transition metal catalyst to improve the oxygen scavenging efficiency can be used.

The term “transition metal catalyst” or “transition metal compound”, as used herein, means those transition metal compounds, also referred to as catalysts, that activate or promote the oxidation of the oxidizable component of the composition by ambient oxygen.

The transition metal functions to catalyze oxygen scavenging by the oxygen scavenging polymer, increasing the rate of scavenging and reducing the induction period. Though not to be bound by theory, useful transition metals include those which can readily interconvert between at least two oxidation states. See Sheldon, R. A.; Kochi, J. K.; “Metal-Catalyzed Oxidations of Organic Compounds” Academic Press, New York 1981.

Preferably, the transition metal is in the form of a salt, with the transition metal selected from the first, second or third transition series of the Periodic Table. Suitable metals include, but are not limited to, cobalt, manganese, iron, nickel, copper, rhodium, vanadium, aluminum, chromium, zinc, ruthenium and mixtures thereof. The oxidation state of the metal when introduced need not necessarily be that of the active form. The metal is preferably cobalt, iron, nickel, manganese, or copper; more preferably cobalt or manganese; and most preferably cobalt. Suitable inorganic or organic counterions for the metal include, but are not limited to, at least one member selected from the group of carboxylates, oxides, carbonates, chlorides, dioxides, hydroxides, nitrates, phosphates, sulfates, silicates, or mixtures thereof. Preferably a suitable counterion is carboxylate selected from the group comprising stearate, acetate, oleate, palmitate, caprylate, propionate, 2-ethylhexanoate, neodecanoate, octanoate, lactate, maleate, acetylacetonate, linoleate, tallate, and naphthenate, preferably C₁₋₂₀ alkanoates.

In some embodiments, the transition metal catalyst may include, but is not limited to, a transition metal salt of i) a metal selected from the group consisting of cobalt, manganese, iron, nickel, copper, rhodium, vanadium, aluminum, chromium, zinc, ruthenium and mixtures thereof, and ii) a carboxylate selected from the group comprising stearate, acetate, oleate, palmitate, caprylate, propionate, 2-ethylhexanoate, neodecanoate, octanoate, lactate, maleate, acetylacetonate, linoleate, tallate naphthenate, and mixtures thereof, preferably C₁₋₂₀ alkanoates.

Suitable metal carboxylate catalyst include, but are not limited to, cobalt stearate, cobalt oleate, cobalt 2-ethylhexanoate, and cobalt neodecanoate, ferric stearate, cerium stearate, manganese stearate, vanadium stearate. Particularly preferable salts include cobalt stearate, cobalt oleate, cobalt 2-ethylhexanoate, cobalt neodecanoate, and mixture thereof.

In some embodiments, the composition comprises at least 50 ppm by weight of at least one transition metal catalyst; preferably at least 75 ppm by weight; preferably at least 100 ppm by weight; preferably at least 200 ppm by weight, preferably at least 300 ppm, preferably at least 400 ppm, preferably at least 500 ppm based on the total weight of the composition. Preferably, the composition comprises at least 50 ppm by weight of at least one metal carboxylate; preferably at least 75 ppm by weight; preferably at least 100 ppm by weight; preferably at least 200 ppm by weight, preferably at least 300 ppm, preferably at least 400 ppm, preferably at least 500 ppm based on the total weight of the composition.

In some embodiments, the composition further comprises at least one photoinitiator additive. When a photoinitiator is used, its primary function is to enhance and facilitate the initiation of oxygen scavenging upon exposure to radiation. The amount of photoinitiator can vary. For example, the amount can depend on the oxidizable compounds used, the wavelength and intensity of radiation used, the nature and amount of antioxidants used, as well as the type of photoinitiator used. The amount of photoinitiator also depends on how the scavenging component is used. For instance, if the photoinitiator-containing component is placed underneath a layer which is somewhat opaque to the radiation used, more initiator may be needed.

For instance, it is often preferable to add a photoinitiator, or a blend of different photoinitiators, to the compositions used to prepare the oxygen scavenger, if antioxidants are included to prevent premature oxidation of that composition.

Suitable photoinitiators are well known to those skilled in the art. Non-limiting examples of suitable photoinitiators include radical photoinitiators such as the benzophenone class, or cationic type photoinitiators. Specific examples include, but are not limited to, [2-hydroxy-4-(octyloxy)phenyl]phenyl-methanone (Chimassorb®81), 1,3,5-tris(4-benzoylphenyl)benzene, isopropylthioxanthone (ITX), bis(2,4,6-trimethylbenzoyl)phenylphosphineoxide (IRGACURE®819), 2,4,6-trimethylbenzoyldiphenylphosphine oxide, ethyl-2,4,6-trimethylbenzoylphenyl phosphinate, bis(2,6-dimethoxybenzoyl)-2,4,4-trimethylpentyl phosphine oxide, 4,4′-benzoylmethyl diphenyl sulfide (BMS), benzophenone, o-methoxybenzophenone, acetophenone, o-methoxy-acetophenone, acenaphthenequinone, methyl ethyl ketone, valerophenone, hexanophenone, α-phenyl-butyrophenone, p-morpholinopropiophenone, dibenzosuberone, 4-morpholinobenzophenone, benzoin, benzoin methyl ether, 4-o-morpholinodeoxybenzoin, p-diacetylbenzene, 4-aminobenzophenone, 4′-methoxyacetophenone, α-tetralone, 9-acetyl phenanthrene, 2-acetylphenanthrene, 10-thioxanthenone, 3-acetylphenanthrene, 3-acetylindole, 9-fluorenone, 1-indanone, 1,3,5-triacetylbenzene, thioxanthen-9-one, xanthene-9-one, 7-H-benz[de]anthracen-7-one, benzoin tetrahydropyranyl ether, 4,4′-bis(dimethylamino)-benzophenone, 1′-acetonaphthone, 2′-acetonaphthone, acetonaphthone and 2,3-butanedione, benz[a]anthracene-7,12-dione, 2,2-dimethoxy-2-phenylacetophenone, α,α-diethoxyacetophenone, α,α-dibutoxyacetophenone, etc.

Singlet oxygen generating photosensitizers such as Rose Bengal, methylene blue, and tetraphenyl porphine may also be employed as photoinitiators. Polymeric initiators include poly(ethylene carbon monoxide) and oligo[2-hydroxy-2-methyl-1-[4-(1-methylvinyl)phenyl]propanone]. Use of a photoinitiator is preferable because it generally provides faster and more efficient initiation.

In some embodiments, the composition further comprises from 100 to 10000 ppm by weight of at least one photoinitiator; preferably from 150 to 8000 ppm; preferably from 200 to 6000 ppm; preferably from 250 to 4000 ppm; preferably from 300 to 2000 ppm of at least one photoinitiator based on the total weight of the composition.

In some embodiments, the composition further comprises at least one antioxidant additive. In some embodiments, the composition comprises two or more antioxidants. Suitable antioxidants may be found in Zweifel, Hans, ISBN 354061690X, Springer-Verlag 1998. Non-limiting examples of suitable antioxidant include primary i.e. hindered phenols, secondary antioxidants i.e. trivalent phosphorous compounds, and the like. Preferred antioxidants for use in composition can be chosen among:

(i) hindered phenols,
(ii) hindered amine light stabilizers (HALS),
(iii) hindered amine light stabilizers comprising sterically hindered phenol moieties,
(iv) aryl phosphites;
(v) thiols; and
(vi) mixtures of at least two antioxidants independently chosen from groups (i) to (v).

Preferred hindered phenol antioxidants include pentaerythritol tetrakis(3-(3,5-di-tert-butyl-4-hydroxyphenyl)propionate) (Irganox®1010), octadecyl-3-(3,5-di-tert-butyl-4-hydroxyphenyl)-propionate (Irganox®1076), 2,6-di(t-butyl) 4-methyl-phenol(BHT), 2,2′-methylene-bis(6-t-butyl-p-cresol), 1,3,5-tris(3,5-di-tert-butyl-4-hydroxybenzyl)-1,3,5-triazine-2,4,6(1H,3H,5H)-trione (Irganox®3114 by BASF), 3,3′,3′,5,5′,5′-hexa-tert-butyl-a,a′,a′-(mesitylene-2,4,6-triyl)tri-p-cresol (Irganox®1330 by BASF), and the like.

Preferred hindered amine light stabilizers (HALS) include those comprising a 2,2,6,6-tetramethylpiperidine moiety and derivatives thereof, including polymers containing them, such as polymethylsiloxane polymers.

Preferred hindered amine light stabilizers comprising sterically hindered phenol moieties include for example Tinuvin® 144; Tinuvin® 622 SF, Tinuvin® 770 DF; Cyasorb® UV 3853, Cyasorb® UV 3529, Cyasorb® UV 3346.

Preferred aryl phosphites include triphenylphosphite, tris-(nonylphenyl)phosphite and the like.

Preferred thiols include dilaurylthiodipropionate and the like.

In some embodiments, the composition further comprises from 100 to 3000 ppm by weight of at least one antioxidant; preferably comprises from 120 to 2800 ppm; preferably comprises from 140 to 2600 ppm; preferably comprises from 160 to 2400 ppm; preferably comprises from 180 to 2200 ppm; preferably comprises from 200 to 2000 ppm, based on the total weight of the composition.

In some embodiments, the composition further comprises at least one phosphite stabilizer additive. Non-limiting examples of suitable phosphite stabilizer additives include tris(2,4-ditert-butylphenyl)phosphite (Igrafos® 168), bis(2,4-di-tert-butylphenyl) pentaerythritol diphosphite (Ultranox 626), and tetrakis(2,4-di-tert-butylphenyl)-4,4-biphenyldiphosphonite (Irgafos PEPQ).

In some embodiments, the composition further comprises from 100 to 2000 ppm by weight of at least one phosphite stabilizer additive preferably comprises from 120 to 1800 ppm; preferably comprises from 140 to 1600 ppm; preferably comprises from 160 to 1400 ppm; preferably comprises from 180 to 1200 ppm; preferably comprises from 200 to 1000 ppm, based on the total weight of the composition.

In some embodiments, the composition further comprises at least one acid scavenger additive. Non-limiting examples of suitable acid scavenger additive include aluminum magnesium carbonate hydroxide (hydrate) (DHT-4V), and calcium stearate.

In some embodiments, the composition further comprises from 100 to 1000 ppm by weight of at least one acid scavenger additive preferably comprises from 120 to 900 ppm; preferably comprises from 140 to 800 ppm; preferably comprises from 160 to 700 ppm; preferably comprises from 180 to 600 ppm; preferably comprises from 200 to 500 ppm, based on the total weight of the composition.

Preparing the Composition

Any process known in the art can be applied for preparing the composition used in the invention.

The present invention also encompasses a process for preparing a composition comprising the steps of
contacting at least 1.0% by weight of polybutadiene based on the total weight of the composition, wherein said polybutadiene has a number average molecular weight Mn of from 1000 to 10000 g/mol as determined by gel permeation chromatography (GPC) as described in the specification under the Determination methods;
with at least a polypropylene component.

In some embodiments, said contacting step comprises melt blending the polybutadiene and the polypropylene component, in a single step. The blending may occur by introducing the polybutadiene and the polypropylene component, into a system capable of combining and melting the components. For example, the blending may be accomplished by introducing the polybutadiene and the polypropylene component, into a batch mixer, continuous mixer, single screw extruder or twin screw extruder, for example, to form a homogeneous mixture or solution while providing temperature conditions so as to melt the blend components, thereby producing an oxygen-scavenging composition.

In an embodiment, the composition is prepared by melt blending; preferably in in an extruder or roll mixer. In an embodiment, the composition is melt blended at a temperature of at least 90° C., for example at least 95° C., for example at least 100° C., for example ranging from 100° C. to 240° C. More preferably, the composition is extruded at a temperature ranging from 100° C. to 220° C.

In some embodiments, contacting of the above-mentioned components may generally occur in a two-step process. In a first step, the polybutadiene and the propylene carrier of the propylene component, may be melt blended. Subsequently, in a second step, the propylene and other optional ingredients may be introduced and melt blended with the first polymer blend. In some embodiments said first step is carried out at a temperature ranging from 45° C. to 75° C.

Applications

In an embodiment, the compositions thereof may be formed into a wide variety of articles such as films, containers, bags, and packaging materials, for example, by polymer processing techniques known to one of skill in the art, such as forming operations including film, sheet, as well as blow moulding, injection moulding, rotary moulding, and thermoforming, for example. Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, for example, in food-contact and non-food contact application. Moulded articles include single and multilayer constructions in the form of bottles, tanks, large hollow articles, rigid food containers and toys, for example.

The present invention can be further illustrated by the following examples, although it will be understood that these examples are included merely for purposes of illustration and are not intended to limit the scope of the invention unless otherwise specifically indicated.

### EXAMPLES

Unless otherwise indicated, all percentages in the following examples, as well as throughout the specification, are percentages by weight.

Determination Methods

The melt flow index (MFI) of the polypropylene and of the porous polypropylene carrier was determined according to ISO 1133:1997, condition M, at a temperature 230° C. and a 2.16 kg load.

Density of the polypropylene was measured according to ISO 1183-1:2012 method A at a temperature of 23° C.

The bulk density of the porous polypropylene carrier was determined according to EN ISO 60:1999.

Density of the polybutadiene was measured according to ISO1675:1985.

The molecular weight (Mₙ (number average molecular weight)) of the polybutadiene was determined by size exclusion chromatography (SEC) and in particular by gel permeation chromatography (GPC). Briefly, an Alliance 2095 from Waters was used: a polybutadiene (PBu) solution with a concentration of ±1 mg/ml was obtained by dissolving the PBu in tetrahydrofuran (THF) (stabilized with 0.025% of BHT) at room temperature (20-25° C.) for 1 hour, and filtrating the sample on a polytetrafluoroethylene (PTFE) 0.45μ membrane filter. Injection volume: ±50 μl. Column temperature: 35° C. One Mixed C column from Agilent was used with a flow rate of 1 ml/min. Detector: Refractive index W2414 (Waters). Detector temperature 30° C. Calibration: narrow standards of polystyrene (PS) (commercially available). Calculation of molecular weight: no Mark-Houwink correction.

The vinyl content of polybutadiene was determined by ¹H nuclear magnetic resonance (¹H NMR). The ¹H NMR spectrum was recorded to characterize the double bonds in this sample, while the ¹³C spectra were recorded to have a fingerprint of the products. The ¹³C NMR spectra of the polybutadiene dissolved in CDCl₃ were recorded at room temperature using the 500 MHz BBO probe, and their ¹H spectra were recorded using the 400 MHz DUAL probe.

The cis-trans content of polybutadiene was determined by ¹H NMR as described herein above.

The Grafted chains type PE content was determined by ¹H NMR as described herein above. Brookfield viscosity of the polybutadiene was determined according to ISO 2555:1989 at a temperature 25° C.

Scanning electron microscope (SEM) was used for the measurement of the size of polybutadiene nodules in the polypropylene matrix. After preparation of an analysis surface, the samples were impregnated with OSO₄. The analysis surface was then smoothed with an ultramicrotome using a diamond knife. Several images were taken using backscattered electron signal (chemical contrast function) at different magnifications ranging from the general view to the detail view of the nodules. The polybutadiene nodules being treated with OSO₄ appeared as clear (white) spots on the images, while the polypropylene remained dark. The size distribution of polybutadiene nodules was also measured on a series of images taken at a magnification of 10000×.

The volatiles content of the composition was determined by Automated Thermal Desorption Gas Chromatography (ATD/GC) with flame ionization detection (FID) for quantitative analysis and mass spectrometry for qualitative analysis. The technique comprised a thermal desorption of the volatiles organic compounds of the composition in an oven at 150° C. The compounds were driven by a helium stream and trapped on a TENAX adsorbent cartridge cooled to −30° C. The volatile compounds were then injected onto the chromatographic separation column by reheating the trap at 230° C., and then separated and detected. Calculations were performed using an external calibration curve using 1-hexene as reference. The compounds were identified on the basis of their retention time.

The melt viscosity as a function of shear rate was measured by Dynamic rheometry analyses (RDA). Dynamic rheometry analyses (RDA) were performed on an ARES rheometer from TA Instruments (Waters SA), measured on parallel plates with a diameter of 25 mm. Temperature was 230° C., and the scanning frequency was from 0.1 to 320 rad/s. It is a measure of the resistance to flow of material placed between two parallel plates rotating with respect to each other with an oscillatory motion. The apparatus comprises a motor that transmits a sinusoidal deformation to the sample. The sample then transmits the resulting constraint, said resulting constraint being also sinusoidal. The material to be studied can be a solid attached between two anchoring points or it can be melted between the two plates. The dynamic rheometer allows the simultaneous measurement of both the elastic modulus and the viscous modulus of the material. Indeed, the resulting sinusoidal constraint is displaced by a phase angle δ with respect to the imposed deformation and it is mathematically possible to decompose the resulting sinusoid into:
a first sinusoid in phase with the initial deformation that represents the elastic component of the material. Said component conserves energy.
a second sinusoid displaced by a phase angle of π/2 with respect to the initial deformation that represents the viscous component. Said component dissipates energy into heat.

The initial deformation is represented by the formula γ=γ₀ sin (ωt) wherein ω is the frequency. The resulting constraint is thus of the form τ=τ₀ sin (ωt+δ). The complex modulus is given by the formula G=τ/γ. The complex modulus can be decomposed into the elastic modulus G′ and the viscous modulus G″ defined respectively as G′=G cos (δ) and G″=G sin(δ). The complex viscosity is defined as G/ω. At constant temperature and constant deformation amplitude, G″ and G″ can be measured for different values of ω. The measurements were carried out under the following operating conditions: a constant operating temperature of 230° C., —parallel plates separated by 1.5 mm, —maximum deformation maintained at 10%. The elastic component G′ and the viscous component G″ can be graphed as a function of frequency ω. The point of intersection between the elastic and viscous curves, called the cross-over point (COP), is characterized by a frequency ω_{c} and a viscosity component G_{c}. The cross-over point is characteristic of each polymer and is a function of the molecular weight and of the molecular distribution.

Tensile properties (Elastic Modulus, elongation at break) were measured according to ISO527/1A:2012 at 23° C. The test specimens having a dimension of the 1A type were prepared by injection moulding according to EN ISO 1873-2:2007.

Izod was measured at 23° C. according to ISO 180:2000 (V notch type 1A) using a Zwick 5113 pendulum impact tester (Zwick GmbH & Co. KG, Ulm, Germany) with a 1 J hammer, impact speed 3.5 m/s and start angle of 124°.

Gels content: Gels were determined by visual counting using “Optical control systems” (OCS®) (www.ocsgmbh.com) as gel inspection system. The compositions were extruded into a film (OCS films) using the OCS equipment, which comprised an extruder of the type ME connected to a cast film unit which is connected to a Film Surface Analyzer FSA100 from Optical Control Systems. Film thickness was 100 μm.

### Example 1

In this example, the following components were used:

Polypropylene PP1 is a polypropylene homopolymer powder ex-reactor produced with a Ziegler-Natta catalyst, having MFI of 3 g/10 min as determined according to ISO 1133:1997, at 230° C. and under a load of 2.16 kg and a xylene soluble of 3.8%. This powder is used for the production of PP2 pellets.

Polypropylene PP2 is a commercially available homopolymer with a MFI of 3 g/10 min as determined according to ISO 1133:1997, at 230° C. and under a load of 2.16 kg and a density of 0.905 g/cm³ (ISO 1183-1) commercially available from TOTAL refining and Chemicals as PPH 4060.

PBu1 is a polybutadiene produced from grafting 4500 g/mol unsaturated (low vinyl) polybutadiene backbone (RICON® 131), adducted with two 5000 g/mol poly(ethylene-co-butene) side branches. PBu1 has a number average molecular weight Mn of 7876 g/mol as determined by GPC as described above and a Brookfield viscosity at 30° C. of 52300 cps (ISO 2555:1989).

PBu2 is a polybutadiene produced from grafting 4500 g/mol of the unsaturated (low vinyl) polybutadiene backbone (RICON® 131), adducted with five 5000 g/mol poly(ethylene-co-butene) side branches. PBu2 has a number average molecular weight Mn of 7536 g/mol as determined by GPC as described above and a Brookfield viscosity at 30° C. of 65700 cps (ISO 2555:1989).

These PBu1 and PBu2 are polybutadiene oligomers onto which hydrogenated polybutadiene chains (i.e., PE-like chains with many ethyl branches) have been grafted. There are theoretically 3 grafted chains for PBu1 and 5 chains grafted for PBu2. The ¹³C NMR spectra of these PBus dissolved in CDCl₃ were recorded at room temperature using the 500 MHz BBO probe, and their ¹H spectra were recorded using the 400 MHz DUAL probe.

According to the ¹H spectra, the proportions of polybutadiene (which contains double bonds) are given below in Table 1. Table 1 shows the content of the different types of butadiene and amount of grafted chains in PBu1 and PBu2, as determined by ¹H NMR as described hereinabove. The values are indicated in in weight % (wt. %), based on the total weight of the corresponding PBu.

TABLE 1

| | PBu1 | PBu2 |
|---|---|---|
| Butadiene C + T (cis + trans) | 14.3% | 8.1% |
| Butadiene V (vinyl) | 3.6% | 3.2% |
| Grafted chains type PE | 82.1% | 88.8% |

The unsaturated (low vinyl) polybutadiene backbone used in the preparation of PBu1 and PBu2 was Ricon® 131MA5, which is a low molecular weight maleinized polybutadiene (polybutadiene functionalized with Maleic Anhydride) having a number average molecular weight Mₙ of 5300 g/mol, 28% vinyl functionalized with malonic acid (determined by ¹H NMR), and a Brookfield viscosity at 25° C. of 15000 cps (ISO 2555:1989), commercially available from TOTAL Cray Valley.

The unsaturated (low vinyl) polybutadiene backbone further comprised 950 ppm of butylated hydroxytoluene (2,6-di-tert-butyl-4-methyl phenol, CAS No. 128-37-0, commercially available from Sasol as BHT and 440 ppm of Irganox®565 (4-[[4,6-bis(octylthio)-1,3,5-triazin-2-yl]amino]-2,6-bis(1,1-dimethylethyl)-phenol, CAS No. 991-84-4, commercially available from BASF Corporation).

The poly(ethylene-co-butene) side branches used in the preparation of PBu1 and PBu2 were obtained using Krasol HLBH 50001, which is an hydroxyl-terminated hydrogenated polybutadiene having a number average molecular weight Mn of 5000 g/mol, commercially available from TOTAL Cray Valley. Krasol HLBH 50001 was further mixed 20 ppm Lowinox® 22M46 stabilizer from Addivant (2,2′-methylenebis(6-t-butyl-4-methylphenol), CAS 119-47-1).

Porous polypropylene carrier PPC1 is a microporous carrier resin completely made from microporous PP homopolymer, having a MFI of 2.1 g/10 min (ISO 1133, 230° C./2.16 kg) and a bulk density of 95+/−20 kg/m³ (DIN EN ISO 60:1999), having a void content ranging from 84+/−5% as determined by Membrana Internal Method (Membrana Gmbh, Germany)), commercially available from Membrana GmbH as Accurel® XP100-84.

Irganox®1010 is a sterically hindered phenolic antioxidant (Pentaerythritol Tetrakis(3-(3,5-di-tert-butyl-4-hydroxyphenyl)propionate), CAS number 6683-19-8), commercially available from Ciba Specialty Chemicals.

Irgafos®168 is a commercial antioxidant (tris(2,4-ditert-butylphenyl)phosphite, CAS number 31570-04-4), commercially available from Ciba Inc.

DHT-4V is a halogen scavenger (antiacid) known as Mg—Al hydrotalcite (aluminum magnesium carbonate hydroxide (hydrate)) (CAS number 11097-59-9), commercially available from Kisuma Chemicals BV.

Different compositions were prepared. The components of the compositions are shown in Table 2. Unless otherwise stated the amounts are given in weight % (wt. %), based on the total weight of the composition. Where amounts are stated in ppm, it is based on weight and with respect to the total weight of the composition.

TABLE 2

| | Composition | Composition | Composition | Composition |
|---|---|---|---|---|
| Component | 1 | 2 | 3 | 4 |
| PP1 | 80.0% | 80.0% | | |
| PP2 | | | 90.0% | 80.0 % |
| PBu1 | 10.0% | | | |
| PBu2 | | 10.0% | | |
| PPC1 | 10.0% | 10.0% | | |
| Composition 1 | | | 10.0% | |
| Composition 2 | | | | 20.0 % |
| Irganox ® 1010 | 750 ppm | 750 ppm | | |
| Irgafos ® 168 | 750 ppm | 750 ppm | | |
| DHT-4V | 280 ppm | 280 ppm | | |

For compositions 1 and 2, the corresponding PBu was pre-mixed with PPC1 for 12 hours at a temperature of 50° C., and then the remaining ingredients were blended and extruded. Compositions 3 and 4 were blended and extruded. Composition 3 comprised 1.0 wt % of PBu1. Composition 4 comprised 2.0 wt % of PBu2.

The compositions were extruded on Brabender 20/40 extruder, using the following conditions:
Twin screw co-rotating, 20 mm screw diameter, L/D=40
Screw speed=200 rpm
Temperature profile=180/190/190/190/190/190° C.

The ¹H NMR spectra of polypropylene compositions dissolved in a 1,2,4-trichlorobenzene (TCB)/C₆D₆ mixture were recorded with 1000 scans using the 400 MHz DUAL probe and using the 500 MHz cryoprobe at 130° C. (higher quality spectrum on the 400 MHz, but faster measurement on the cryoprobe). The samples were prepared by dissolving samples of the compositions in 1,2,4-trichlorobenzene (TCB, 99%, spectroscopic grade) at 130° C. and occasional agitation to homogenize the samples, followed by the addition of hexadeuterobenzene (C₆D₆, spectroscopic grade). Table 3 shows the content of the different types of butadiene and amount of grafted chains in Compositions 3 and 4, as determined by ¹H NMR. The values are indicated in in weight % (wt. %), based on the total weight of the corresponding composition.

TABLE 3

| | Composition 3 | | Composition 4 | |
|---|---|---|---|---|
| | 400 MHz | 500 MHz | 400 MHz | 500 MHz |
| Butadiene C + T | 0.09% | 0.08% | 0.10% | 0.07% |
| (cis + trans) | | | | |
| Butadiene V (vinyl) | 0.04% | 0.03% | 0.04% | 0.04% |
| Grafted chains on PBu | 99.9% | 99.9% | 99.9% | 99.9% |

The mechanical properties of Compositions 3 and 4 were analyzed on moulded tensile bars, and compared with those of polypropylene. The results are shown on Table 4. The amount of volatile fractions in these compositions is also limited, as shown on Table 5.

TABLE 4

| | Composition 1 | Composition 2 | PP2 |
|---|---|---|---|
| E Modulus (MPa) | 1163 | 1126 | 1237 |
| Elongation at break (%) | 507 | 418 | 389 |
| lzod 23° C. (kJ/m²) | 3.96 | 3.97 | 4.16 |

TABLE 5

| | Composition 1 | Composition 2 | PP2 |
|---|---|---|---|
| Volatile components | (ppm) | (ppm | (ppm) |
| Sum of C2-C4 | <1 | <1 | <1 |
| Sum of C6 | 3 | 3 | 3 |
| Sum between C6-C9 | <1 | <1 | <1 |
| Sum of C9 | 7 | 8 | 6 |
| Sum of C12 | 32 | 37 | 25 |
| Sum of >C12-C24 | 142 | 164 | 117 |
| Total of volatiles | 185 | 213 | 152 |

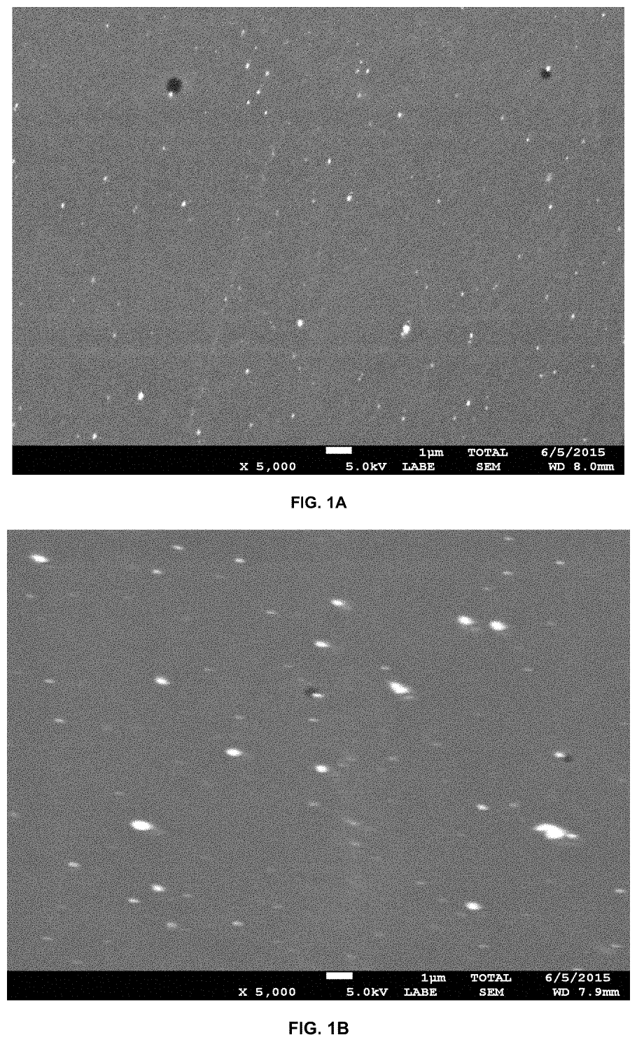

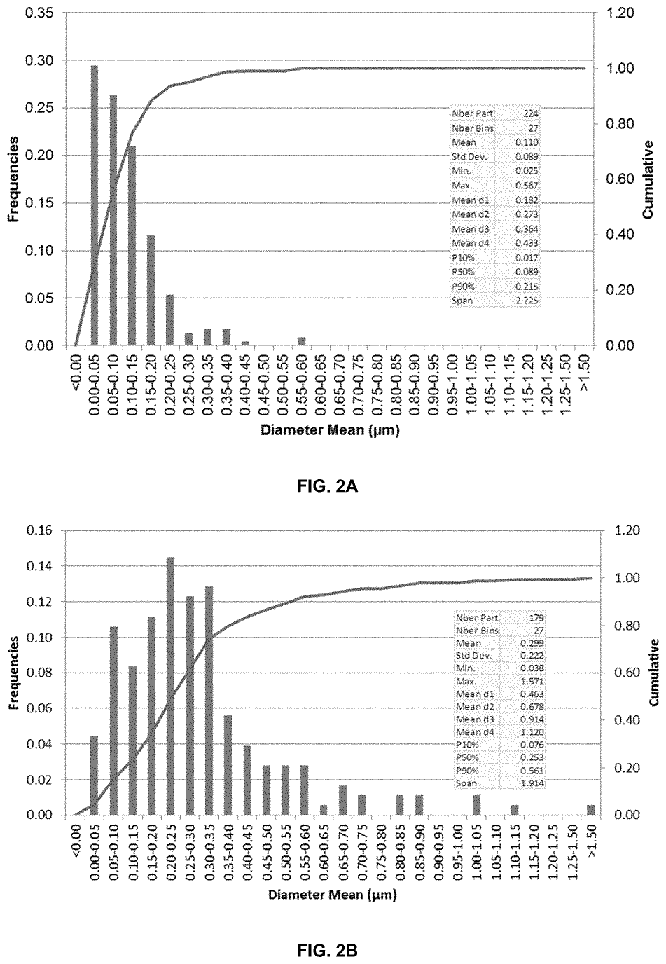

Compositions 3 and 4 were also analyzed by SEM microscopy (FIGS. 1A and 1B). Surprisingly, Composition 4 (FIG. 1B) shows bigger nodules of polybutadiene despite the higher branching level. The polybutadiene nodule size of Composition 3 (FIG. 1A) is close to a tenth of a micron, indicating a good level of dispersion. The PBu nodule size in the polypropylene matrix of compositions 3 and 4 was also determined by SEM microscopy (FIG. 2A and FIG. 2B respectively).

### Example 2

In this example, the following components were used:

Polypropylene PP1 as described in Example 1.

PBu1 as described in Example 1.

PBu2 as described in Example 1.

STECO 090HV is a commercial cobalt 9.5% stearate (CAS No. 13586-84-0), commercially available from Shepherd Mirecourt S.A.S.

Irganox®1010 as described in Example 1.

Irgafos®168 as described in Example 1.

DHT-4V as described in Example 1.

Two concentrate compositions 5.1 and 5.2 were prepared. The components of the concentrate compositions are shown in Table 6. Unless otherwise stated the amounts are given in weight % (wt. %), based on the total weight of the composition. Where amounts are stated in ppm, it is based on weight and with respect to the total weight of the composition.

TABLE 6

| | concentrate | concentrate |
|---|---|---|
| Component | composition 5.1 | composition 5.2 |
| PP1 | 99% | 98% |
| STECO 090HV | 1% | 2% |
| Irganox ® 1010 | 750 ppm | |
| Irgafos ® 168 | 750 ppm | 500 ppm |
| DHT-4V | 280 ppm | 280 ppm |

These compositions were extruded on Brabender 20/40 extruder, using the following conditions:
Twin screw co-rotating, 20 mm screw diameter, L/D=40
Screw speed=200 rpm
Temperature profile=180/190/190/190/190/190° C.

Two compositions were prepared. The components of the compositions are shown in Table 7. Unless otherwise stated the amounts are given in weight % (wt. %), based on the total weight of the composition.

TABLE 7

| Component | Composition 6 | Composition 7 |
|---|---|---|
| PP1 | 85% | 75% |
| Composition 1 from Example 1 | 10% | |
| Composition 2 from Example 2 | | 20% |
| Concentrate composition 5.1 | 5% | 5% |

The compositions were extruded on Brabender 20/40 extruder, using the following conditions:
Twin screw co-rotating, 20 mm screw diameter, L/D=40
Screw speed=200 rpm
Temperature profile=180/190/190/190/190/190° C.

Composition 6 comprised 1.0 wt % of PBu1. Composition 7 comprised 2.0 wt % of PBu2. Both compositions comprised 500 ppm STECO 090HV. The pellets were packed under N₂ in sealed tight bags. Table 8 shows the melt flow (ISO 1133 at 230° C. and a 2.16 kg load), as well as the melt viscosity of pellets obtained from Compositions 6 and 7.

Optical control systems (OCS) films from Compositions 6 and 7 were prepared. These films were packed under N₂ in sealed tight bags to protect them from oxidation. Table 8 shows some properties of the obtained films, compared with films prepared from PP2. The gels increased with the presence of polybutadiene, but this did not affect the extrusion of the films.

TABLE 8

| | Composition 6 | Composition 7 | |
|---|---|---|---|
| MFI 2.16 kg (g/10 min) | 3.97 | 3.70 | |
| Viscosity (Pa · s) at | 2550 | 2577 | |
| 1 s⁻¹ shear rate | | | |
| OCS films | Composition 6 | Composition 7 | PP2 |
| OCS (gels/m²) | 5000 | 2660 | 57 |
| Volatile components | (ppm) | (ppm) | (ppm) |
| Sum of C2-C4 | <1 | <1 | <1 |
| Sum of C6 | <1 | 1 | <1 |
| Sum between C6-C9 | <1 | <1 | <1 |
| Sum of C9 | 4 | 6 | 5 |
| Sum of C12 | 25 | 16 | 23 |
| Sum of >C12-C24 | 245 | 221 | 192 |
| Total of volatiles | 275 | 244 | 221 |

### Example 3

In this example, the following components were used:

Polypropylene PP1 as described in Example 1.

Polypropylene PP2 as described in Example 1.

Polypropylene PP3 is a commercially available propylene homopolymer with a MFI of 1.8 g/10 min as determined according to ISO 1133, at 230° C. and under a load of 2.16 kg and a density of 0.905 g/cm³ (ISO 1183-1) commercially available from TOTAL refining and Chemicals as PPH 3060.

Polypropylene PP4 is a commercially available propylene homopolymer with a MFI of 0.3 g/10 min as determined according to ISO 1133, at 230° C. and under a load of 2.16 kg and a density of 0.905 g/cm³ (ISO 1183-1) commercially available from TOTAL refining and Chemicals as PPH 1060.

Polybutadiene PBu3 is a low molecular weight homopolymer of polybutadiene commercially available from TOTAL Cray Valley as RICON® 131. PBu3 has a number average molecular weight Mₙ of 4500 g/mol, a density of 0.89 g/cm³, a 1,2-vinyl content of 28% and a Brookfield viscosity at 25° C. of 2750 cps as measured using the test methods described herein above. PBu3 contains 111 ppm of 3,6-di-tertiary-butyl-4-methylphenol (CAS No. 128-37-0, also known as butylated hydroxytoluene (BHT)).

Porous polypropylene carrier PPC1 as described in Example 1.

Irganox®1010 as described in Example 1.

Irgafos®168 as described in Example 1.

DHT-4V as described in Example 1.

Different compositions were prepared. The components of the compositions are shown in Table 9. Unless otherwise stated the amounts are given in weight % (wt. %), based on the total weight of the composition. Where amounts are stated in ppm, it is based on weight and with respect to the total weight of the composition.

TABLE 9

| | Composition | Composition | Composition | Composition |
|---|---|---|---|---|
| Component | 8 | 9 | 10 | 11 |
| PP1 | 80% | | | |
| PP2 | | 90% | | |
| PP3 | | | 80% | |
| PP4 | | | | 80% |
| PBu3 | 10% | 1% | 10% | 10% |
| PPC1 | 10% | | 10% | 10% |
| Composition 8 | | 10% | | |
| Irganox ® 1010 | 750 ppm | | 750 ppm | 750 ppm |
| Irgafos ® 168 | 750 ppm | | 750 ppm | 750 ppm |
| DHT-4V | 280 ppm | | 280 ppm | 280 ppm |

The compositions were extruded on Brabender 20/40 extruder, using the following conditions:
Twin screw co-rotating, 20 mm screw diameter, L/D=40
Screw speed=200 rpm
Temperature profile=180/190/190/190/190/190° C.

The pellets were packed under N₂ in sealed tight bags. Table 10 shows the content of the different types of butadiene and amount of grafted chains in Compositions 8 and 9, as determined by ¹H NMR, as described herein above. The values are indicated in in weight % (wt. %), based on the total weight of the corresponding composition.

TABLE 10

| | PBu1 | PBu3 | Composition 8 | Composition 9 |
|---|---|---|---|---|
| Butadiene C + T | 14.3% | 79% | 7.37% | 0.68% |
| (cis + trans) | | | | |
| Butadiene V (vinyl) | 3.6% | 21% | 2.10% | 0.19% |
| Grafted chains type PE | 82.1% | 0% | 90.5% | 99.1% |

Table 11 shows the melt flow index (MFI) (ISO 1133 at 230° C. and a 2.16 kg load), as well as the melt viscosity of pellets obtained from Compositions 8 and 9.

TABLE 11

| | Composition 8 | Composition 9 | Composition 11 |
|---|---|---|---|
| MFI (g/10 min) | 17.2 | 8.3 | 4.4 |
| Viscosity (Pa · s) at | 2259 | 2185 | 12212 |
| 1 s⁻¹ shear rate | | | |

The mechanical properties of Compositions 8, 9 and 11 were analyzed on moulded tensile bars; the results are shown on Table 12.

TABLE 12

| | Composition 8 | Composition 9 | Composition 11 |
|---|---|---|---|
| E Modulus (MPa) | 1086 | 1262 | 1444 |
| Elongation at break | 387 | 135 | 88 |
| (%) | | | |
| lzod 23° C. (kJ/m²) | 5.08 | 4.31 | 10.11 |

OCS films were prepared from Compositions 8 and 9. These films were packed under N₂ in sealed tight bags to protect them from oxidation. Table 13 shows some properties of the obtained films.

TABLE 13

| OCS films | Composition 8 | Composition 9 |
|---|---|---|
| OCS (gels/m²) | 1013 | 398 |
| Volatile components | (ppm) | (ppm) |
| Sum of C2-C4 | 0.1 | 0.1 |
| Sum of C6 | 0.4 | 0.5 |
| Sum between C6-C9 | 52 | 7 |
| Sum of C9 | 9 | 5 |
| Sum of C12 | 19 | 24 |
| Sum of >C12-C24 | 179 | 150 |
| Total of volatiles | 260 | 187 |

The resulting gel count for OCS films produced from Compositions 8 and 9 was very good.

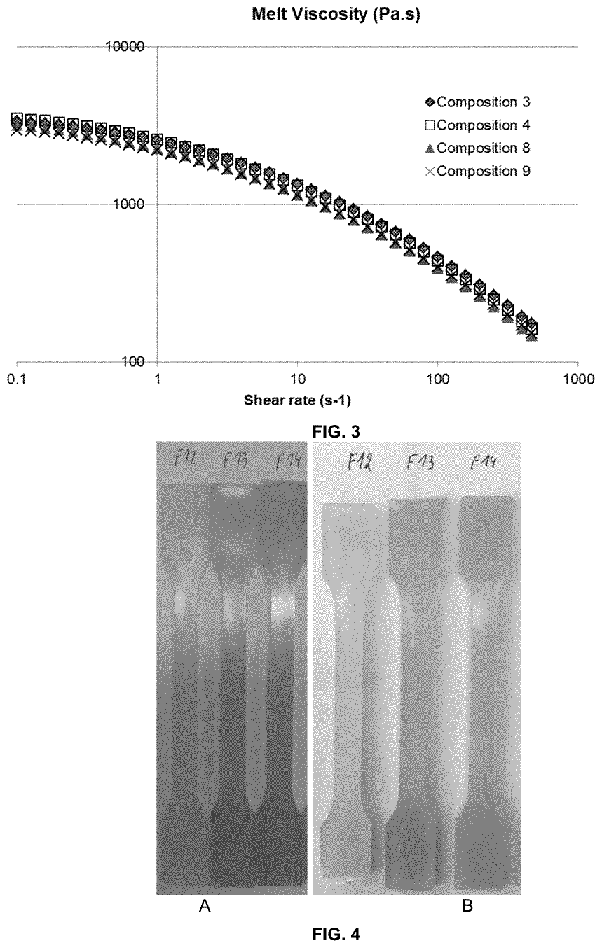

The melt viscosity as a function of shear rate of compositions 3, 4, 8 and 9 according to the invention was measured and the results are shown in FIG. 3.

### Example 4

In this example, the following components were used:

Polypropylene PP1 as described in Example 1.

Polybutadiene PBu3 as described in Example 3.

Polybutadiene PBu4 is a commercially available low molecular weight homopolymer of polybutadiene. PBu4 has a number average molecular weight Mn of 4500 g/mol (determined by GPC), a 1,2-vinyl content of 28% (¹H NMR) and a Brookfield viscosity at 25° C. of 2750 cps as measured using the test methods described herein above. Commercially available from TOTAL Cray Valley as RICON® 131. The butylated hydroxyl toluene (BHT) present in this product was removed by solubilizing in pentane and filtrating over silica.

Porous polypropylene carrier PPC1 as described in Example 1.

STECO 090HV as described in Example 2.

Chimassorb® 81 is an ultraviolet light absorber of the benzophenone class ([2-hydroxy-4-(octyloxy)phenyl]phenyl-methanone, CAS No. 1843-05-6), commercially available from BASF BASF Schweiz AG.

Irganox®1076 is a commercial sterically hindered phenolic antioxidant (Octadecyl-3-(3,5-di-tert.butyl-4-hydroxyphenyl)-propionate, CAS number 2082-79-3), commercially available from Ciba.

Irgafos®168 as described in Example 1.

DHT-4V as described in Example 1.

Different compositions were prepared. The components of the compositions are shown in Table 14. Unless otherwise stated the amounts are given in weight % (wt. %), based on the total weight of the composition. Where amounts are stated in ppm, it is based on weight and with respect to the total weight of the composition.

TABLE 14

| Component | Composition 12 | Composition 13 | Composition 14 |
|---|---|---|---|
| PP1 | 75% | 75% | 75% |
| Composition 5.2 from | 5% | 5% | 5% |
| Example 2 | | | |
| PBu3 | 10% | | |
| PBu4 | | 10% | 10% |
| PPC1 | 10% | 10% | 10% |
| Chimassorb ® 81 | 1000 ppm | 1000 ppm | 1000 ppm |
| Irganox ® 1076 | 300 ppm | 300 ppm | |
| Irgafos ® 168 | 750 ppm | 750 ppm | 500 ppm |
| DHT-4V | 280 ppm | 280 ppm | 280 ppm |

The compositions were extruded on Brabender 20/40 extruder, using the following conditions:
Twin screw co-rotating, 20 mm screw diameter, L/D=40
Screw speed=200 rpm
Temperature profile=180/190/190/190/190/190° C.

These compositions comprised 1000 ppm of STECO 090HV. The pellets were packed under N₂ in sealed tight bags. Pellets and moulded plaques obtained from Compositions 12, 13 and 14 were submitted to a discoloration test. The test specimens were prepared by injection moulding according to EN ISO 1873-2:2007. The material turned yellow during processing (FIG. 4A); after 17 months of ageing the material showed varying color change (FIG. 4B). Additionally the color of the moulded plaques and the unprocessed pellets were compared with RAL color standards (RAL gemeinnützige GmbH, Germany, standardized colors, color fan deck RAL K5 containing 213 RAL CLASSIC colors, https://www.ral-farben.de/en/PRODUCTS-SHOP/RAL-CLASSIC/RAL-K5.html?force_sid=3nf2mbvur7c5u2Idloq4k69ij7) and assigned a RAL color (identified by a number); Table 15 shows the RAL colors of the pellets and the plaques at the beginning of the test and after 17 months. The order of yellowing was composition 14> composition 13> composition 12 both at the beginning of the test and after 17 months.

TABLE 15

| | | Plaques at | Plaques |
|---|---|---|---|
| | Pellets | beginning of test | after 17 months |
| Composition 12 | RAL 1013 | RAL 1013 | RAL 1015 |
| Composition 13 | RAL 1013 | RAL 1014 | RAL 1002 |
| Composition 14 | RAL 1013 | RAL 1032 | RAL 1032 |

The melt flow index (MFI) (ISO 1133 at 230° C. and a 2.16 kg load) of the pellets was measured and re-measured after 4 and 17 months of oxidation; the results are shown on Table 16.

TABLE 16

| | MFI at start | MFI after 4 | MFI after 17 |
|---|---|---|---|
| | of test | months oxidation | months oxidation |
| | (g/10 min) | (g/10 min) | (g/10 min) |
| Composition 12 | 4 | 27 | degraded |
| Composition 14 | 4 | 15 | degraded |

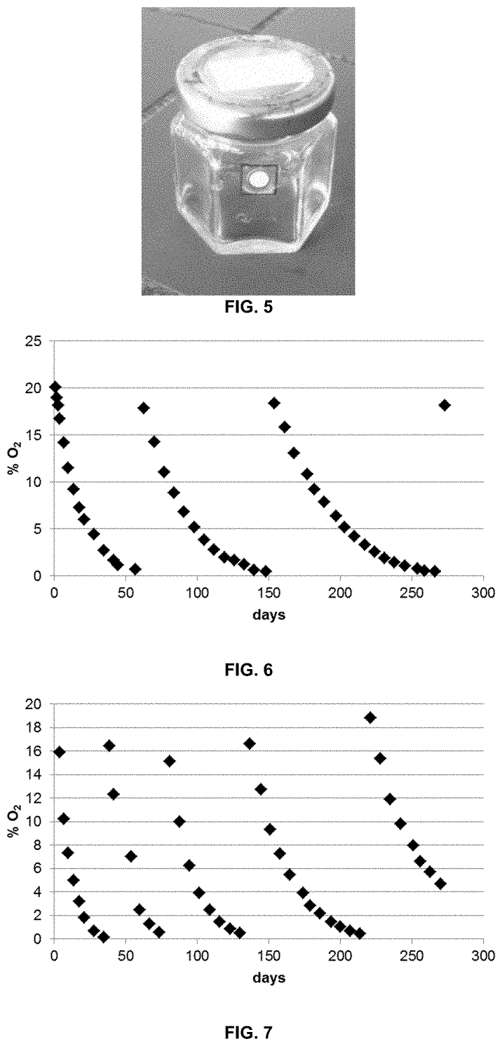

To test the composition's capacity to capture oxygen (O₂), 2 g of pellets made of each of the compositions according to the invention were placed in a tight glass jar of 50 ml volume, which contained a non-invasive oxygen sensor OxyDot, commercially available from OxySense, placed inside and attached to a wall of the jar (FIG. 5). The OxyDot oxygen sensor senses oxygen concentration within the sealed jar, which is measurable using an external probe (OxySense portable oxygen analyzer) applied outside the glass jar wall that emits light causing a fluorescence excitation and emission from the OxyDot in proportion to the oxygen content of the jar. The measurements were performed at regular intervals to build a kinetics curve for Compositions 12 and 14 (FIGS. 6 and 7 respectively).

When O₂ concentration reached a value <0.5%, the jar was opened to fill it with fresh air and return it to normal O₂ concentration; the jar was then resealed, and measurements were continued to allow the calculation of cumulative amount of captured O₂.

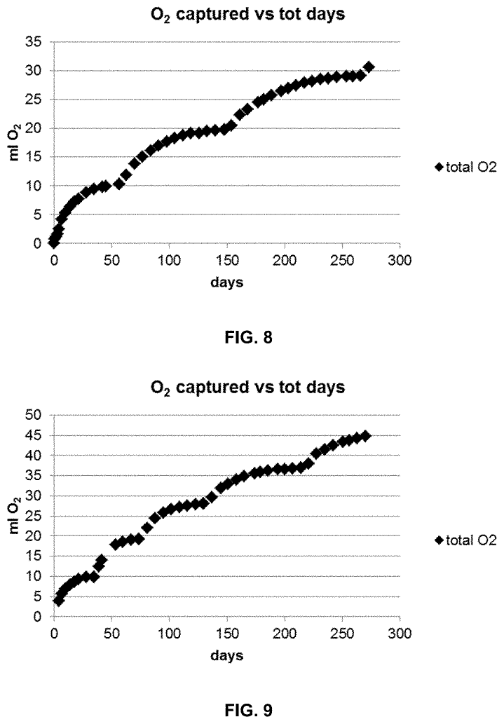

Using these data, the amount of O₂ capture knowing the jar volume was 50 ml. Composition 12 showed a capture of 29 ml of O₂ after 250 days (FIG. 8), while Composition 14 captured 40 ml of O₂ in the same period (FIG. 9).

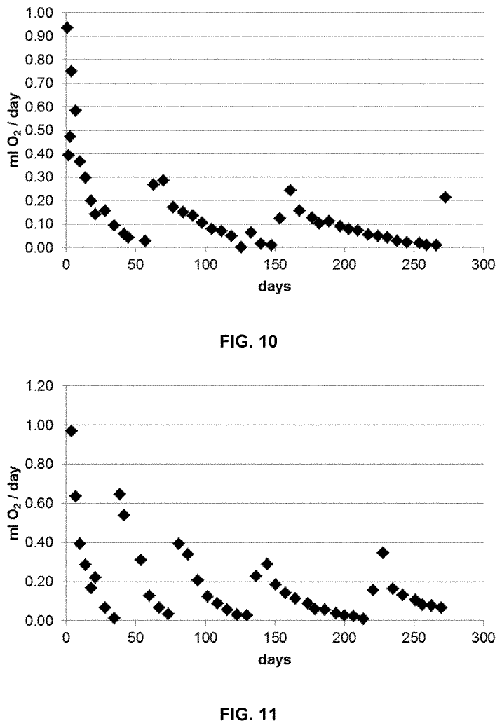

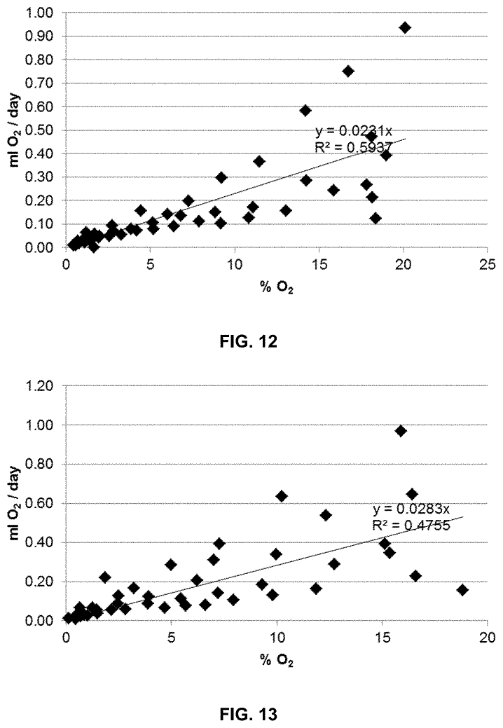

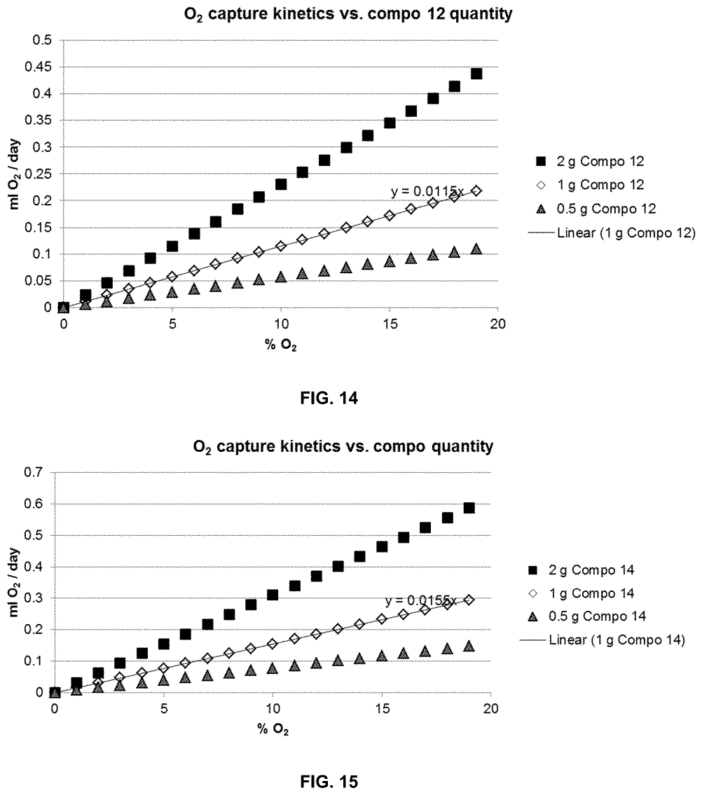

The rate of O₂ capture of each of the composition, determined as the ml of captured O₂ per day, was plotted against number of days for each of Compositions 12 and 14 (FIGS. 10 and 11 respectively), as well as against the O₂ concentration (FIGS. 12 and 13 respectively). It was observed that there is a first order relationship between the speed of O₂ capture and the O₂ concentration. This allowed determining a mathematical model based on a capture depending on the O₂ concentration: For Composition 12=0.0115 ml O₂/day/% O₂/g of composition (FIG. 14). For Composition 14=0.01545 ml O₂/day/% O₂/g of composition (FIG. 15).

The oxygen capture tests performed in the jar and the above mathematical models were used to estimate the oxidation capability of different articles comprising compositions according to the invention.

Simulation of a Multilayer packaging containing an external layer made of standard PP, a middle layer with O₂ barrier properties such as an EVOH layer and an inner layer made of a composition according to the invention (PP—OS) was performed as described below. The simulation included also the comparison with a Multilayer packaging containing an external layer made of standard PP, a middle layer with O₂ barrier properties such as an EVOH layer without the inner layer made of a composition according to the invention (w/o PP—OS).

For such simulation, using composition 12, the following hypotheses were made:
Dimensions of packaging (cm), length=(H1), width=(J1), height (L1)
   In this example, H1=20 cm, J1=12 cm, L1=3 cm
(E2) Percentage of the total packaging surface containing the PP—OS (%)
   In this example, E2=100%
(C2) Percentage of air volume in the packaging vs. the packaging content (%)
   In this example, C2=5%
(R3) Oxygen capture capability (ml O₂/day/% O₂/g PP—OS)
   In this example (PP—OS: Composition 12), R3=0.0115
(YI) 100% yield of O₂ capture (ml O₂)
   In this example YI=85 ml O₂ for 1 g Composition 12
(F5) Thickness of PP—OS layer (microns)
   In this example, F5=50 μm
(DE) Density of PP—OS (g/cm³)
   In this example, DE=0.9 g/cm³
(I5) Concentration of O₂ in the packaging at day 0(%); if a “Modified Atmosphere Packaging” technology is used, this value can be comprised at any concentration between 0 and 20%
   In this example, I5=5%
(PO) Permeation of O₂ through the O₂ barrier layer at 0% O₂ concentration behind the layer (ml O₂/m²/day)
   In this example, PO=0.12
(TO) O₂ content in ambient air (%)
   In this example, TO=19

Then, the following calculations were made for each day (iterations day by day from day 1 to last day of simulation):
For each day, the following data remained constant:
   (C5) Free volume of air (ml): H1×J1×L1×C2/100
   (D5) Total surface exposed to air (m²): ((H1×J1×2)+(J1×L1×2)+(H1×L1×2))/10000
   (E5) Surface of packaging containing PP—OS exposed to air (m²): D5×E2/100
   (G5) Quantity of PP—OS (g): E5×F5×DE×C2/100 (conservative approach considering only a fraction of PP—OS layer is in contact with inner air volume and capable to capture 02)
At day 0, the following data were calculated
   (J_day0 with PP—OS) and (L_day0 without PP—OS) Volume of O₂ inside the packaging (ml): I5×C5/100
   (O_day0) capture of O₂ (ml)=0
   (I_day0 with PP—OS) and (K_day0 without PP—OS) Concentration of O₂ in the packaging (%): I5
   (P_day0) total O₂ captured since day 0 (ml)=0
   (Q_day0) OS yield (%): 0
At day 1, the following data were calculated in the hypothesis of the presence of a PP—OS layer:
   (M_day1 with PP—OS) permeation of O₂ (ml): PO×(TO−(I_day0))/TO×D5
   (O_day1) capture of O₂ (ml):R3×(I_day0)×G5
   (J_day1) volume of O₂ in the packaging (ml): J_day0+M_day1−O_day1
   (I_day1) Concentration of O₂ in the packaging (%): J_day1/C5×100
   (P_day1) total O₂ captured since day 0 (ml)=P_day0+O_day1
   (Q_day1) OS yield (%): P_day1/YI/G5×100
At day d, the following data were calculated with the hypothesis of the presence of a PP—OS layer, d varying from 1 to 450 in this example
   (M_day_d with PP—OS) permeation of O₂ (ml): PO×(TO−(I_day_d−1))/TO×D5
   (O_day_d) capture of O₂ (ml): R3×(I_day_d−1)×G5
   (J_day_d) volume of O₂ in the packaging (ml): J_day_d−1+M_day_d−O_day_d
   (I_day_d) Concentration of O₂ in the packaging (%): J_day_d/C5×100
   (P_day_d) total O₂ captured since day 0 (ml): P_day_d−1+O_day_d
   (Q_day_d) OS yield (%): P_day_d/YI/G5×100
      According to the generated data, a maximum yield of 17% was considered for composition 12
      When Q_day_d reach a yield greater than 17%, O_day_d takes the value 0
In parallel, also at day 1, the following data were calculated with the hypothesis of the absence of a PP—OS layer:
   (N_day1) permeation of O₂ (ml): PO×(TO−(K_day0))/TO×D5
   (L_day1) volume of O₂ in the packaging (ml): L_day0+N_day1
   (K_day1) Concentration of O₂ in the packaging (%): L_day1/C5×100
At day d, the following data were also calculated with the hypothesis of the absence of a PP—OS layer, d varying from 1 to 350 in this example
   (N_day_d) permeation of O₂ (ml): PO×(TO−(K_day_d−1))/TO×D5
   (L_day_d) volume of O₂ in the packaging (ml): L_day_d−1+N_day_d
   (K_day_d) Concentration of O₂ in the packaging (%): L_day_d/C5×100

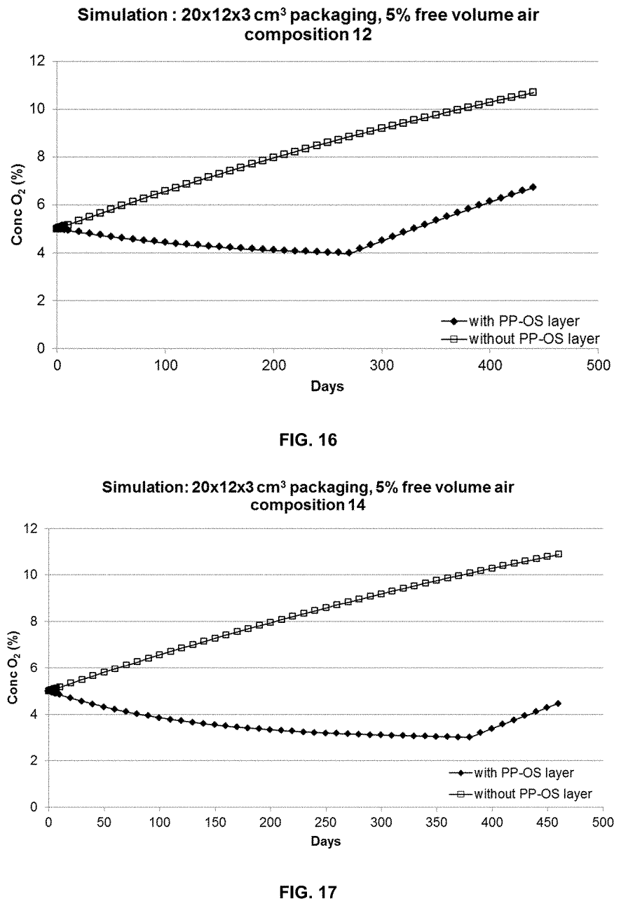

FIG. 16 shows an estimation of the oxidation capability of a 20×12×3 cm³ multilayer packaging, having a 5% free internal volume air and comprising a 50 μm inner layer made from Composition 12 next to one 10 μm layer made of ethylene vinyl alcohol (EVOH), and compared to the oxidation capability of a 20×12×3 cm³ multilayer packaging, having a 5% free internal volume air without the 50 μm inner layer made from Composition 12 next to one 10 μm layer made of ethylene vinyl alcohol (EVOH).

The same experiment was repeated using Composition 14. The same above described protocol was used but with two different hypotheses:
(R3) Oxygen capture capability (ml O₂/day/% O₂/gr PP—OS)
   In this example, R3=0.0155
According to the generated data, a maximum yield of 25% was considered for composition 14; When Q_day_d reach a yield greater of 25%, O_day_d takes the value 0.

FIG. 17 shows an estimation of the oxidation capability of a 20×12×3 cm³ multilayer packaging, having a 5% free internal volume air and comprising a 50 μm inner layer made from Composition 14 next to one 10 μm layer made of ethylene vinyl alcohol (EVOH), and compared to the oxidation capability of a 20×12×3 cm³ multilayer packaging, having a 5% free internal volume air without the 50 μm inner layer made from Composition 14 next to one 10 μm layer made of ethylene vinyl alcohol (EVOH).

1.-15. (canceled)

16. An oxygen-scavenging composition comprising:
at least 1.0% by weight of polybutadiene based on the total weight of the composition, wherein the polybutadiene has a number average molecular weight Mn of from 1000 to 10000 g/mol as determined by gel permeation chromatography (GPC) as described in the specification under the Determination methods; and
a polypropylene component.

17. The composition according to claim 16, wherein the polypropylene component comprises polypropylene having a melt flow index of from 0.3 to 150.0 g/10 min as determined according to ISO 1133:1997 at 230° C. and under a load of 2.16 kg.

18. The composition according to claim 16, wherein the polypropylene component comprises a porous polypropylene carrier, wherein the porous polypropylene carrier has a bulk density of at most 300 kg/m³, the bulk density being measured according to DIN EN ISO 60:1999.

19. The composition according to claim 16, wherein the polybutadiene has a Brookfield viscosity of from 500 to 20000 cps as determined according to ISO 2555:1989 at 25° C.

20. The composition according to claim 16, wherein the polybutadiene has a 1,2 vinyl content of at least 0.5%, as determined by ¹H NMR spectroscopy as described in the specification under the Determination methods.

21. The composition according to claim 16, wherein the polybutadiene is a polybutadiene homopolymer.

22. The composition according to claim 16, wherein the composition further comprises at least one metal carboxylate catalyst additive.

23. The composition according to claim 22, wherein the metal of the at least one metal carboxylate catalyst additive is a transition metal.

24. The composition according to claim 16, wherein the composition further comprises at least one photoinitiator additive.

25. The use of a composition according to claim 16, for the manufacture of an article.

26. An article comprising an oxygen scavenging composition according to claim 16.

27. The article according to claim 26, wherein the article is an oxygen scavenging film.

28. A food packaging comprising an oxygen scavenging composition according to any one of claim 26.

29. A mono or multi-layer article comprising an oxygen-scavenging layer comprising the composition according to any one of claim 26.

30. The mono or multi-layer article according to claim 29, wherein the article is a film.
